(19) United States
(12) Patent Application Publication
(10) Pub. No.: US 2025/0368846 A1
(43) Pub. Date: Dec. 4, 2025

(54) INKJET FLUID SET

(71) Applicant: Hewlett-Packard Development Company, L.P., Spring, TX (US)

(72) Inventors: David Michael Ingle, San Diego, CA (US); Phillip C. Cagle, San Diego, CA (US); Jeffrey Matthew Stubbs, San Diego, CA (US)

(21) Appl. No.: 18/707,859

(22) PCT Filed: Nov. 18, 2021
(86) PCT No.: PCT/US2021/059922

§ 371 Date: May 6, 2024

(51) Int. Cl. C09D 11/40; B41M 5/00

(52) U.S. Cl. CPC C09D 11/40; B41M 5/0017; B41M 5/0047

(57) ABSTRACT

An inkjet fluid set includes a pre-treatment fluid and an inkjet ink. The pre-treatment fluid includes a first aqueous vehicle and a water resistance and adhesion promoting cationic polymer dissolved or dispersed in the first aqueous vehicle. The inkjet ink includes a second aqueous vehicle, a pigment dispersed throughout the second aqueous vehicle, and multi-phase latex particles dispersed throughout the second aqueous vehicle. Each of the multi-phase latex particles includes at least two different heteropolymers defining at least two different phases of the multi-phase latex particle.

### BACKGROUND

In addition to home and office usage, inkjet technology has been expanded to high-speed, commercial and industrial printing. High-speed printing applications have also expanded the type of media used in inkjet printing beyond traditional porous paper-based media. For example, non-porous, non-paper-based flexible or rigid media are used in product packaging, signage, and other applications. Inkjet printing of aqueous inks on non-porous, non-paper-based media is substantially different than inkjet printing on porous paper-based media. On porous paper-based media, ink drying occurs primarily by penetration of the ink into the media pore structure, and image quality is highly dependent upon the rate of ink penetration. On non-porous, non-paper-based media, the ink does not penetrate into the media, and thus the colorant remains on the surface of the media. As such, image quality is highly dependent upon controlling ink wetting and migration across the non-porous surface. Furthermore, image durability on non-porous media is highly dependent on film formation of a polymeric binder present in the ink, and the chemical resistance and/or adhesion properties of the binder.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic illustration depicting an example of an inkjet fluid set and an inkjet printing kit;

FIGS. 2A through 2C are schematic illustrations of examples of the multi-phase latex particles disclosed herein;

FIG. 3 is a schematic diagram of a printing system;

FIG. 4 is a bar graph depicting the chemical resistance results for prints generated with three different example pre-treatment fluids and one comparative example pre-treatment fluid on different rigid media;

FIG. 5 is a bar graph depicting the Taber score results for prints generated with four different example pre-treatment fluids and one comparative example pre-treatment fluid on a rigid medium;

FIG. 6 is a bar graph depicting the dry/wet coin scratch results for prints generated with two different example pre-treatment fluids and one comparative example pre-treatment fluid and different amounts of an overcoat fluid on a rigid medium;

FIG. 7 is a bar graph depicting the dry rub results for prints generated with one example pre-treatment fluid and one comparative example pre-treatment fluid and different amounts of an overcoat fluid on a rigid medium;

FIG. 8 is a bar graph depicting the dry rub results for prints generated with two example pre-treatment fluids and one comparative example pre-treatment fluid and different amounts of an overcoat fluid on another rigid medium; and

FIG. 9 is a bar graph depicting the chemical resistance results for prints generated with four different example pre-treatment fluids on a rigid medium.

### DETAILED DESCRIPTION

Inkjet printing aqueous inks on non-porous, non-paper-based media can be challenging, in part because the medium surface can have relatively poor water permeability and absorption. The addition of latex particles to aqueous inks can improve the compatibility of an aqueous inkjet ink with a non-porous, non-paper-based medium, in part because the latex particles can coalesce to form a polymeric film on the medium surface. This polymeric film can entrap and protect the colorant, which improves the print quality. However, some polymeric films exhibit poor adhesion to the medium surface.

Disclosed herein is a pre-treatment fluid that is particularly suitable for improving the adhesion of a latex-based inkjet ink to a non-porous, non-paper-based medium. The pre-treatment fluid includes a water resistance and adhesion promoting cationic polymer dissolved or dispersed in a first aqueous vehicle. Thus, the cationic polymer is specifically selected to improve water resistance of the resulting print and also to improve the adhesion between the non-porous, non-paper-based medium and the latex-based inkjet ink.

The cationic polymer in the pre-treatment fluid is soluble or dispersible in the aqueous vehicle of the pre-treatment fluid, but is capable of imparting water resistance to the print that is generated. In some examples, the cationic polymer is not hygroscopic, which helps to improve the water resistance as the printed cationic polymer does not absorb moisture from the air. The water resistance imparted by the cationic polymer may be due, in part, to its molecular weight. The relatively high molecular weight of the cationic polymers disclosed herein may exhibit slow solubility kinetics, rendering them essentially non-redispersible in water. The longer polymer chains may also lead to strong chain entanglement, which may contribute to a durable film that is water resistant.

The cationic polymer in the pre-treatment fluid also contains adhesion promoting amine moieties. As used herein, adhesion promoting amine moieties are those that have a lone pair of electrons that are capable of binding to substrates with oxygen-containing functionality, such as carboxyls and hydroxyls. The amine moieties may also be reactive with amine and/or thiol functionalities. When the latex-based inkjet ink is printed on the pre-treated non-porous, non-paper-based medium and cured to form the polymeric film, the interaction between the pre-treatment fluid and the non-porous, non-paper-based medium enhances the adhesion of the polymeric film to the non-porous, non-paper-based medium. Thus, the pre-treatment fluid acts as a tie coating that binds well to both the non-porous, non-paper-based medium and the latex-based inkjet ink.

The high water resistance and improved adhesion may desirably influence other properties, including durability, e.g., in terms of ink retention, scratch resistance, chemical resistance, etc.

Throughout this disclosure, a weight percentage that is referred to as “wt % active” refers to the loading of an active component of a dispersion or other formulation that is present, e.g., in the ink. For example, a surfactant may be present in a water-based formulation (e.g., stock solution or dispersion) before being incorporated into the aqueous vehicle. In this example, the wt % actives of the surfactant accounts for the loading (as a weight percent) of the surfactant molecules that are present in the ink, and does not account for the weight of the other components (e.g., water, etc.) that are present in the stock solution or dispersion with the surfactant molecules.

The term “molecular weight” as used herein refers to weight average molecular weight (Mw), the units of which are g/mol or Daltons.

### Inkjet Fluid Set and Printing Kit

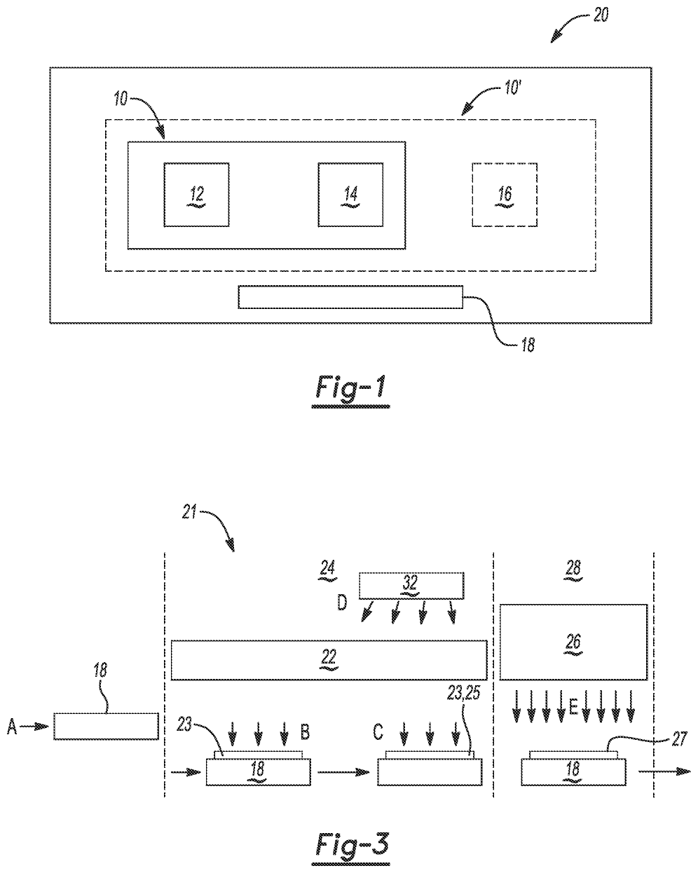

Examples of the inkjet fluid set and the inkjet printing kits disclosed herein are shown schematically in FIG. 1. One example of the inkjet fluid set 10 includes: a pre-treatment fluid 12 including a first aqueous vehicle and a water resistance and adhesion promoting cationic polymer dispersed in the first aqueous vehicle; and an inkjet ink 14 including a second aqueous vehicle, a pigment dispersed throughout the second aqueous vehicle, and multi-phase latex particles dispersed throughout the second aqueous vehicle, each of the multi-phase latex particles including at least two different heteropolymers defining at least two different phases of the multi-phase latex particle. Another example of the inkjet fluid set 10′ includes the pre-treatment fluid 12, the inkjet ink 14, and an overcoat fluid 16. Several examples of each of the fluids 12, 14, 16 are disclosed herein, and it is to be understood that any example of the pre-treatment fluid 12, the inkjet ink 14, and the overcoat fluid 16 may be used in the examples of the inkjet fluid set 10.

In the inkjet fluid sets 10, 10′, the pre-treatment fluid 12 and the inkjet ink 14, or the pre-treatment fluid 12, the inkjet ink 14, and overcoat fluid 16 are maintained separately until utilized together in a printing method. As such, the pre-treatment fluid 12 and the inkjet ink 14, or the pre-treatment fluid 12, the inkjet ink 14, and overcoat fluid 16 may be maintained in separate containers (e.g., respective reservoirs/fluid supplies of respective inkjet cartridges) or separate compartments (e.g., respective reservoirs/fluid supplies) in a single container (e.g., inkjet cartridge).

Each of the fluids 12, 14, 16 are formulated for digital application, e.g., by thermal inkjet printheads or piezoelectric inkjet printheads.

Examples of the inkjet fluid sets 10, 10′ may also be part of an inkjet printing kit 20, which is also shown schematically in FIG. 1. In an example, the inkjet printing kit 20 includes a non-porous, non-paper-based medium 18; the pre-treatment fluid 12 including a first aqueous vehicle and a water resistance and adhesion promoting cationic polymer dispersed in the first aqueous vehicle; and an inkjet ink 14 including a second aqueous vehicle, a pigment dispersed throughout the second aqueous vehicle, and multi-phase latex particles dispersed throughout the second aqueous vehicle, each of the multi-phase latex particles including at least two different heteropolymers defining at least two different phases of the multi-phase latex particle. Another example of the inkjet printing kit 20 includes the non-porous, non-paper-based medium 18, the pre-treatment fluid 12, the inkjet ink 14, and the overcoat fluid 16. It is to be understood that any example of the fluids 12, 14 and/or 16 disclosed herein may be used in the examples of the inkjet printing kit 20.

### Pre-Treatment Fluid

The pre-treatment fluid 12 includes a first aqueous vehicle and an adhesion promoting cationic polymer dispersed in the first aqueous vehicle.

As mentioned herein, the adhesion promoting cationic polymer includes adhesion promoting amine moieties. In an example, the adhesion promoting cationic polymer is selected from the group consisting of a copolymer including an epihalohydrin and an amine; an acrylic emulsion polymer having quaternary and tertiary amine groups; a polycarbodiimide; and combinations thereof.

In one example, the adhesion promoting cationic polymer is a copolymer including an epihalohydrin and an amine. The reaction between the epihalohydrin (e.g., epichlorohydrin) and a polyalkylene polyamine (e.g., ethylenediamine, bishexamethylenetriamine, hexamethylenediamine, etc.) generates an azetidinium-containing polyamine. More particularly, the polyalkylene polyamine reacts with the epihalohydrin to form an epoxide-containing polyamine, which then rearranges by itself to form an azetidinium group:

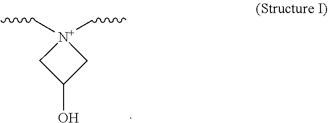

The azetidinium group is attached to R₁ and NR₂ and thus this example of the adhesion promoting cationic polymer may be represented by:

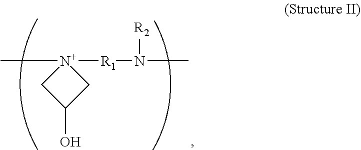

where R₁ can be a substituted or unsubstituted C₂-C₁₂ linear alkyl group and R₂ is H or CH₃. In some additional examples, R₁ can be a C₂-C₁₀, C₂-C₈, or C₂-C₆ linear alkyl group. More generally, there may be from 2 to 12 carbon atoms between amine groups (including azetidinium groups) in Structure II. In other examples, there can be from 2 to 10, from 2 to 8, or from 2 to 6 carbon atoms between amine groups in Structure II. In some examples, where R₁ is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e., R₁ does not include or form part of an amide group). In some additional examples, a carbon atom of R₁ can include a pendent hydroxyl group.

It is to be understood that Structures I and II are not intended to show repeating units, but rather depict the azetidinium group (Structure I) and the azetidinium group attached to other groups of the polyamine (Structure II). These azetidinium-containing polyamines are often referred to as PAmE resins. The polyamine can also include various organic groups, polymeric portions, functional moieties, etc.

As can be seen in Structure II, this example of the copolymer including the epihalohydrin and the amine can include a quaternary amine (e.g., the azetidinium group) and a non-quaternary amine (e.g., a primary amine, a secondary amine, a tertiary amine, or a combination thereof). In some specific examples, the copolymer including the epihalohydrin and the amine can include a quaternary amine and a tertiary amine. In some additional examples, the copolymer including the epihalohydrin and the amine can include a quaternary amine and a secondary amine. In some further examples, the copolymer including the epihalohydrin and the amine can include a quaternary amine and a primary amine. The copolymer including the epihalohydrin and the amine have a ratio of azetidinium groups to other amine groups ranging from 0.1:1 to 10:1. In other examples, the copolymer including the epihalohydrin and the amine can have a ratio of azetidinium groups to other amine groups ranging from 0.5:1 to 2:1. Some examples of commercially available copolymers including the epihalohydrin and the amine that fall within these ranges of azetidinium group to amine groups include POLYCUP™ 7360 and POLYCUP™ 7360A, each of which is available from Solenis LLC.

In another example, the adhesion promoting cationic polymer is an acrylic emulsion polymer having quaternary and tertiary amine groups. Some commercially available examples of the acrylic emulsion polymer having quaternary and tertiary amine groups the RAYCAT® range of polymers, from Specialty Polymers, Inc. In one example, the adhesion promoting cationic polymer is RAYCAT® 78.

In still another example, the adhesion promoting cationic polymer is a polycarbodiimide. Poly(carbodiimide) is characterized as an oligomer or a polymer that includes two or more carbodiimide (—N═C═N—) functional groups. In the examples disclosed herein, the poly(carbodiimide) is a water miscible (e.g., dispersible) polymer containing the carbodiimide groups. The water miscible polymer containing carbodiimide groups may be present in an aqueous-based dispersion. Commercially available examples of such aqueous based dispersions include PICASSIAN® XL-702 (a hydrophilic aqueous poly(carbodiimide), 40% active) and PICASSIAN® XL-732 (a hydrophobic aqueous poly(carbodiimide) (40% active), both from Stahl Polymers.

In one example, the poly(carbodiimide) may be formed by reacting a polyisocyanate in the presence of a carbodiimide catalyst to form a stable polycarbodiimide; terminating and/or chain extending the polycarbodiimide chain by the addition of a compound containing a hydrophilic group and one or more amine and/or hydroxyl functions during or after the polycarbodiimide formation; and dispersing the resulting compound in water, wherein the pH is adjusted to a value between 9 and 14 by the addition of a base and/or a buffer to the water. In this example, any carbodiimide catalyst may be used, such as 1-methylphospholene-1-oxide. Also in this example, any polyisocyanate may be used, such as toluene-2,4-diisocyanate, toluene-2,6-diisocyanate, diphenylmethane-4,4-diisocyanate, 1,4-phenylenediisocyanate, dicyclohexylmethane-4,4′-diisocyanate, 3-isocyanatomethyl-3,5,5-trimethylcyclohexylisocyanate, 1,6-hexyldiisocyanate, 1,4-cyclohexyl-diisocyanate, norbonyldiisocyanate diisocyanate, or a mixture thereof. Also in this example, the compound containing a hydrophilic group and one or more amine and/or hydroxyl functions is a polyethoxy mono- or diol, a polyethoxy/polypropoxy mono- or diol, a polyethoxy mono- or diamine, a polyethoxy/polypropoxy mono- or diamine, a diol or diamine with a polyalkoxy side chain, a hydroxyl- or amine alkylsulfonate, or a dialkylaminoalkylalcohol or amine, or a mixture thereof.

In another example, the poly(carbodiimide) is a decarbonated condensate of one or more diisocyanates selected from the group consisting of hexamethylene diisocyanate (HDI), hydrogenated xylylene diisocyanate (H6 XDI), xylylene diisocyanate (XDI), 2,2,4-trimethyl-hexamethylene diisocyanate (TMHDI), 1,12-diisocyanato-dodecane (DDI), norbornane diisocyanate (NBDI) and 2,4-bis-(8-isocyanatooctyl)-1,3-dioctyl cyclobutane (OCDI).

In any of the examples disclosed herein, the adhesion promoting cationic polymer also has a relatively high molecular weight, which can contribute to its high water resistance. In an example, a weight average molecular weight of the adhesion promoting cationic polymer ranges from about 1,000 to 2,000,000, from about 2,000 to about 1,000,000, from about 5,000 to about 200,000, from about 1,500 to about 150,000, or from about 20,000 to about 1,000,000. In one example, the weight average molecular weight ranges from about 1,000 to about 500,000.

The adhesion promoting cationic polymer has a relatively high charge density, which can help to destabilize and immobilize anionic pigment in the inkjet ink.

The water resistance and adhesion promoting cationic polymer is present in the pre-treatment fluid 12 in an amount ranging from about 1 wt % active to about 10 wt % active based on a total weight of the pre-treatment fluid 12. When the adhesion promoting cationic polymer is incorporated into the pre-treatment fluid 12 as part of a dispersion (e.g., which also includes water), it is to be understood that these percentages account for the weight percent of solid adhesion promoting cationic polymer in the fluid 12, and does not account for the total weight percent of the adhesion promoting cationic polymer dispersion that may be incorporated in the fluid 12.

The adhesion promoting cationic polymer is dissolved or dispersed in an aqueous vehicle. In an example, the aqueous vehicle includes or consists of water, a co-solvent, and a surfactant. In some examples, the aqueous vehicle also includes an acidic pH adjuster.

The co-solvent in the pre-treatment fluid 12 may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, lactams, caprolactams, formamides, acetamides, and long chain alcohols. Examples of such compounds include primary aliphatic alcohols, secondary aliphatic alcohols, 1,2-alcohols, 1,3-alcohols, 1,5-alcohols, alkyldiols, ethylene glycol alkyl ethers, propylene glycol alkyl ethers (e.g., DOWANOL™ TPM (from Dow Chemical)), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples include ethanol, isopropyl alcohol, butyl alcohol, benzyl alcohol, 2-ethyl-2-(hydroxymethyl)-1,3-propane diol (EPHD), dimethyl sulfoxide, sulfolane, ethylene glycol, diethylene glycol, propylene glycol, butylene glycol, triethylene glycol, 1,2-butanediol, 1,5-pentanediol, 1,2-hexanediol, 1,2,6-hexanetriol, glycerin, trimethylolpropane, xylitol, an ethylene oxide adduct of diglycerin, 2-pyrrolidone, 1-(2-hydroxyethyl)-2-pyrrolidone, N-methyl-2-pyrrolidone, cyclohexylpyrrolidone, and triethanolamine.

The co-solvent(s) may be present in the pre-treatment fluid 12 in an amount ranging from about 4 wt % active to about 30 wt % active (based on the total weight of the pre-treatment fluid 12). In an example, the total amount of co-solvent(s) present in the pre-treatment fluid 12 ranges about 15 wt % active to about 25 wt % active (based on the total weight of the pre-treatment fluid 12).

The surfactant in the pre-treatment fluid 12 may be any non-ionic surfactant and/or cationic surfactant.

Examples of the non-ionic surfactant may include siloxane-based gemini surfactants, polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin. More specific examples of suitable non-ionic surfactants include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available non-ionic surfactants include TEGO® Twin 4000 (siloxane-based gemini surfactant), SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK).

Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide.

In any of the examples disclosed herein, the surfactant(s) may be present in the pre-treatment fluid 12 in an amount ranging from about 0.01 wt % active to about 5 wt % active (based on the total weight of the pre-treatment fluid 12). In an example, the surfactant is present in the pre-treatment fluid 12 in an amount ranging from about 0.05 wt % active to about 3 wt % active, based on the total weight of the pre-treatment fluid 12. In another example, the surfactant is present in the pre-treatment fluid 12 in an amount of about 0.7 wt % active, based on the total weight of the pre-treatment fluid 12.

The pre-treatment fluid 12 has a pH ranging from about 3 to about 5. In one example, the pH of the pre-treatment fluid 12 is 4. In some instances, a pH adjuster may be added to the pre-treatment fluid 12 to obtain the desired acidic pH. Examples of suitable pH adjusters for the pre-treatment fluid 12 include acids, such as nitric acid, methanesulfonic acid, succinic acid, etc.

In an example, the total amount of pH adjuster(s) in the pre-treatment fluid 12 ranges from greater than 0 wt % active to about 1 wt % active (based on the total weight of the pre-treatment fluid 12). In another example, the total amount of pH adjuster(s) in the pre-treatment fluid 12 ranges from about 0.01 wt % active to about 0.9 wt % active. In another example, the total amount of pH adjuster(s) in the pre-treatment fluid 12 is about 0.03 wt % active (based on the total weight of the pre-treatment fluid 12). The amount of pH adjuster added depends on the desired pH, and the pH adjuster may be added until the desired pH of the pre-treatment fluid 12 is achieved.

Some examples of the pre-treatment fluid 12 may also include a second cationic polymer dissolved in the aqueous vehicle. The second cationic polymer may be selected for destabilization and immobilization of the pigment in the inkjet ink 14 that is applied on the pre-treatment fluid 12, which contributes to bleed and coalescence control. A polyamine may be a suitable second cationic polymer. One commercially available example of a polyamine that may be used as the second cationic polymer is FLOQUAT™ FL 2350 (from SNF). The second cationic polymer, when included, may be present in an amount ranging from about 3 wt % active to about 7 wt % active, based on a total weight of the pre-treatment fluid 12.

To form examples of the pre-treatment fluid 12, the aqueous vehicle and the cationic polymer are combined together and mixed.

### Inkjet Ink

The inkjet ink 14 includes a second aqueous vehicle, a pigment dispersed throughout the second aqueous vehicle, and multi-phase latex particles dispersed throughout the second aqueous vehicle, each of the multi-phase latex particles including at least two different heteropolymers defining at least two different phases of the multi-phase latex particle.

Examples of the inkjet ink 14 include the pigment. The term “pigment” may include particulate dispersible colorants that can be suspended or dispersed in the aqueous vehicle disclosed herein. The pigment itself can be a self-dispersed pigment or a non-self-dispersed pigment.

The pigment may include inorganic pigments or organic pigments of any desirable color, such as black pigments, white pigments, cyan pigments, magenta pigments, yellow pigments, or the like.

Suitable inorganic pigments include, for example, carbon black. However, other inorganic pigments may be suitable, such as titanium oxide, cobalt blue (CoO—Al₂O₃), chrome yellow (PbCrO₄), and iron oxide.

Suitable organic pigments include, for example, azo pigments including diazo pigments and monoazo pigments, polycyclic pigments (e.g., phthalocyanine pigments, such as phthalocyanine blues and phthalocyanine greens, perylene pigments, perinone pigments, anthraquinone pigments, quinacridone pigments, dioxazine pigments, thioindigo pigments, isoindolinone pigments, pyranthrone pigments, and quinophthalone pigments), nitropigments, nitroso pigments, and the like. Suitable examples of phthalocyanine blues include copper phthalocyanine blue and derivatives thereof (Pigment Blue 15). Suitable examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Suitable examples of anthraquinones include Pigment Red 43, Pigment Red 194 (Perinone Red), Pigment Red 216 (Brominated Pyranthrone Red) and Pigment Red 226 (Pyranthrone Red). Suitable examples of perylenes include Pigment Red 123 (Vermillion), Pigment Red 149 (Scarlet), Pigment Red 179 (Maroon), Pigment Red 190 (Red), Pigment Violet 19, Pigment Red 189 (Yellow Shade Red) and Pigment Red 224. Representative examples of thioindigoids include Pigment Red 86, Pigment Red 87, Pigment Red 88, Pigment Red 181, Pigment Red 198, Pigment Violet 36, and Pigment Violet 38. Suitable examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128 and Pigment Yellow 138, Pigment Yellow 155, Pigment Yellow 83, and Pigment Yellow 213. Such pigments are commercially available in either powder or press cake form from a number of sources including, BASF Corporation, Engelhard Corporation, and Sun Chemical Corporation.

A wide variety of other colored pigments can also be used in the inkjet ink 14. While several examples follow, it is to be understood that the list is not intended to be limiting. For example, colored pigments can be blue, brown, cyan, green, white, violet, magenta, red, orange, yellow, as well as mixtures thereof. The following color dispersions are available from Cabot Corp. CABO-JET™ 250C, CABO-JET™ 260M, and CABO-JET™ 270Y. The following color pigments are available from BASF Corp.: PALIOGEN™ Orange, PALIOGEN™ Orange 3040, PALIOGEN™ Blue L 6470, PALIOGEN™ Violet 5100, PALIOGEN™ Violet 5890, PALIOGEN™ Yellow 1520, PALIOGEN™ Yellow 1560, PALIOGEN™ Red 3871 K, PALIOGEN™ Red 3340, HELIOGEN™ Blue L 6901 F, HELIOGEN™ Blue NBD 7010, HELIOGEN™ Blue K 7090, HELIOGEN™ Blue L 7101F, HELIOGEN™ Blue L6900, L7020, HELIOGEN™ Blue D6840, HELIOGEN™ Blue D7080, HELIOGEN™ Green L8730, HELIOGEN™ Green K 8683, and HELIOGEN™ Green L 9140. The following pigments are available from Ciba-Geigy Corp.: CHROMOPHTAL™ Yellow 3G, CHROMOPHTAL™ Yellow GR, CHROMOPHTAL™ Yellow 8G, IGRAZIN™ Yellow 5GT, IGRALITE™ Rubine 4BL, IGRALITE™ Blue BCA, MONASTRAL™ Magenta, MONASTRAL™ Scarlet, MONASTRAL™ Violet R, MONASTRAL™ Red B, and MONASTRAL™ Violet Maroon B. The following pigments are available from Heubach Group: DALAMAR™ Yellow YT-858-D and HEUCOPHTHAL™ Blue G XBT-583D. The following pigments are available from Hoechst Specialty Chemicals: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, NOVOPERM™ Yellow HR, NOVOPERM™ Yellow FGL, Hansa Brilliant Yellow 10GX, Permanent Yellow G3R-01, HOSTAPERM™ Yellow H4G, HOSTAPERM™ Yellow H3G, HOSTAPERM™ Orange GR, HOSTAPERM™ Scarlet GO, HOSTAPERM™ Pink E, Permanent Rubine F6B, and the HOSTAFINE™ series. The following pigments are available from Mobay Corp.: QUINDO™ Magenta, INDOFAST™ Brilliant Scarlet, QUINDO™ Red R6700, QUINDO™ Red R6713, and INDOFAST™ Violet. The following pigments are available from Sun Chemical Corp.: L74-1357 Yellow, L75-1331 Yellow, and L75-2577 Yellow. Other examples of pigments can include Normandy Magenta RD-2400, Permanent Violet VT2645, Argyle Green XP-111-S, Brilliant Green Toner GR 0991, Sudan Blue OS, PV Fast Blue B2GO1, Sudan III, Sudan II, Sudan IV, Sudan Orange G, Sudan Orange 220, Ortho Orange OR 2673, Lithol Fast Yellow 0991 K, Paliotol Yellow 1840, Lumogen Yellow D0790, Suco-Gelb L1250, Suco-Yellow D1355, Fanal Pink D4830, Cinquasia Magenta, Lithol Scarlet D3700, Toluidine Red, Scarlet for Thermoplast NSD PS PA, E. D. Toluidine Red, Lithol Rubine Toner, Lithol Scarlet 4440, Bon Red C, Royal Brilliant Red RD-8192, Oracet Pink RF, Lithol Fast Scarlet L4300, and white TIPURE R-101. These pigments are available from commercial sources such as Hoechst Celanese Corporation, Paul Uhlich, BASF Corp., American Hoechst, Novartis, Aldrich, DuPont, Ugine Kuhlman of Canada, Dominion Color Company, Magruder, and Matheson.

Examples of black pigments that can be used include carbon pigments. The carbon pigment can be almost any commercially available carbon pigment that provides acceptable optical density and print characteristics. Examples of suitable carbon pigments include carbon black, graphite, vitreous carbon, charcoal, and combinations thereof. Such carbon pigments can be manufactured by a variety of known methods such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as MONARCH™ 1400, MONARCH™ 1300, MONARCH™ 1100, MONARCH™ 1000, MONARCH™ 900, MONARCH™ 880, MONARCH™ 800, MONARCH™ 700, CAB-O-JET™ 200, CAB-O-JET™ 300, REGAL™, BLACK PEARLS, ELFTEX™, MOGUL™, and VULCAN™ pigments; Columbian pigments such as RAVEN™ 7000, RAVEN™ 5750, RAVEN™ 5250, RAVEN™ 5000, and RAVEN™ 3500; Degussa pigments such as Color Black FW 200, RAVEN™ FW 2, RAVEN™ FW 2V, RAVEN™ FW 1, RAVEN™ FW 18, RAVEN™ S160, RAVEN™ FW S170, Special Black™ 6, Special Black™ 5, Special Black™ 4A, Special Black™ 4, PRINTEX™ U, PRINTEX™ 140U, PRINTEX™ V, and PRINTEX™140V.

In some examples, the inkjet ink 14 includes the pigment in an amount of at least 1 wt % active based on the total weight of the inkjet ink 14. In some examples, the inkjet ink 14 includes up to about 20 wt % active pigment by total weight of the inkjet ink 14. In some examples, the pigment is included in the inkjet ink 14 in an amount ranging from about 6 wt % active to about 15 wt % active, or from about 2 wt % active to about 10 wt % active, based on the total weight of the inkjet ink 14. When the pigment is incorporated into the inkjet ink 14 as part of a dispersion (e.g., which also includes water), it is to be understood that these percentages account for the weight percent of solid pigment particles or active pigment particles in the inkjet ink 14, and does not account for the total weight percent of the pigment dispersion that may be incorporated in the inkjet ink 14.

Any of the pigments, such as carbon, phthalocyanine, quinacridone, azo, or other organic pigments set forth herein, may be made self-dispersing, as long as at least one organic group that is capable of dispersing the pigment is attached to the pigment. The organic group that is attached to the pigment includes at least one aromatic group, an alkyl (e.g., C₁ to C₂₀), and an ionic or ionizable group. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like). The alkyl may be branched or unbranched, substituted or unsubstituted. The ionic or ionizable group may be at least one phosphorus-containing group, at least one sulfur-containing group, or at least one carboxylic acid group.

If the pigment is not self-dispersed, an additional dispersant may be included in pigment dispersion, and thus the inkjet ink 14. Examples of suitable dispersants include water-soluble acrylic acid polymers or branched co-polymers of a comb-type structure. Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation. The branched co-polymer of the comb-type structure includes polyether pendant chains and acidic anchor groups attached to the backbone. Specific examples include DISPERBYK®-190 and DISPERBYK®-199, both available from BYK Additives and Instruments, as well as DISPERSOGEN® PCE available from Clariant.

The amount of the dispersant in the pigment dispersion may range from about 0.1 wt % to about 2 wt %, based on the total weight of the dispersion. The pigment dispersion may then be incorporated into the aqueous vehicle so that the dispersant is present in an amount ranging from about 0.01 wt % active to about 0.5 wt % active, based on a total weight of the inkjet ink 14. In one of these examples, the dispersant is present in an amount of about 0.04 wt % active, based on a total weight of the inkjet ink 14.

In other examples, the inkjet ink 14 may be unpigmented or substantially lack a pigment. For example, the inkjet ink 14 may include less than 0.5 wt % of a pigment. In these examples, the inkjet ink 14 is colorless, and may be used as the overcoat fluid 16. Thus, the overcoat fluid 16 may include any of the components of the inkjet ink 14 set forth herein, with the caveat that the overcoat fluid is unpigmented or substantially lack a pigment. In addition to the co-solvents, latex particles, anti-kogation agent, surfactant(s), anti-microbial agent, and deionized water, the colorless inkjet ink 14/overcoat fluid 16 may include a wax dispersion (e.g., a polyethylene wax) in an amount ranging from about 2 wt % active to about 5 wt % active (e.g., 3 wt % active).

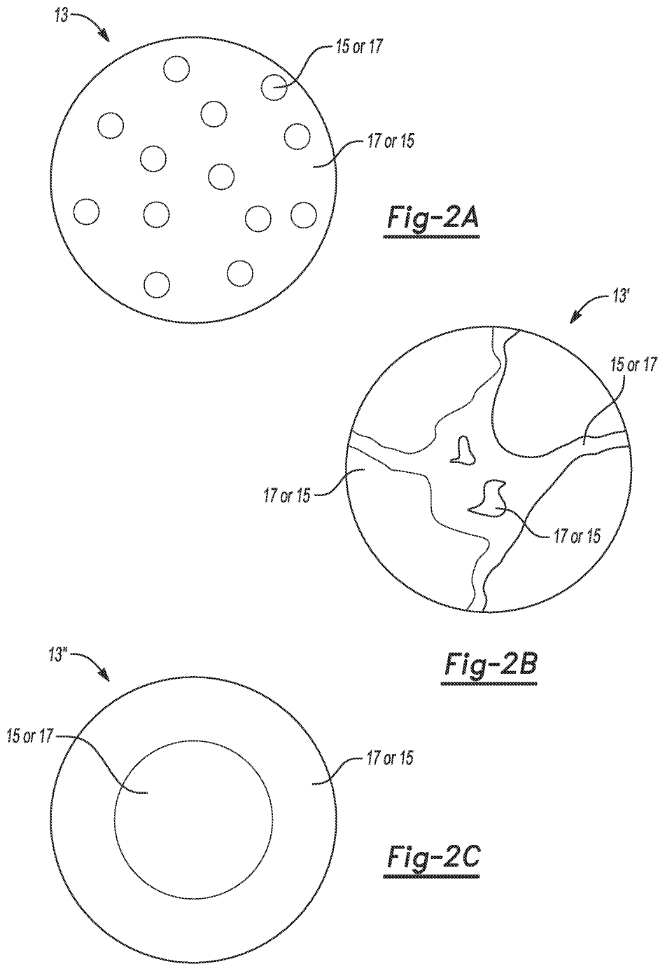

The inkjet ink 14 also includes latex particles. FIG. 2A through FIG. 2C illustrate various examples of the multi-phase latex particles 13, 13′, 13″. Examples of the morphology of the multi-phase latex particles 13, 13′, 13″ are discussed below, but it is to be understood that the designations “15 or 17” and “17 or 15” indicate that when the first heteropolymer 15 makes up one phase, the second heteropolymer 17 makes up the other phase. As such, in FIG. 2A, the heteropolymer 15 may form the phase that is surrounded by the heteropolymer 17, or the heteropolymer 17 may form the phase that is surrounded by the heteropolymer 15. Moreover, while a few example morphologies are schematically illustrated, the two heteropolymers 15, 17 may reside together in any physically separated configuration. While two-phase examples are shown, it is to be understood that the multi-phase latex particles 13, 13′, 13″ may include additional heteropolymers that form additional physically separated phases.

Each of the multi-phase latex particles 13, 13′, 13″ includes at least two different heteropolymers 15, 17 defining at least two different phases of the multi-phase latex particle 13, 13′, 13″; wherein the at least two different heteropolymers 15, 17 are selected such that: i) a cumulative percentage of any heteropolymers of the at least two different heteropolymers 15, 17 including less than 30% of a C6 or greater (meth)acrylate monomer ranges from about 20 wt % to about 80 wt % of a total weight of the multi-phase latex particle 13, 13′, 13″; ii) a cumulative percentage of any heteropolymers of the at least two different heteropolymers 15, 17, having a glass transition temperature (T_{g}) ranging from 15° C. to 75° C. ranges from about 30 wt % to about 70 wt % of the total weight of the multi-phase latex particle 13, 13′, 13″; iii) a cumulative percentage of any heteropolymers of the at least two different heteropolymers having a glass transition temperature (T_{g}) greater than 75° C. is greater than 30 wt % of the total weight of the multi-phase latex particle 13, 13′, 13″; and iv) a cumulative percentage of an aromatic group monomer in the multi-phase latex particle 13, 13′, 13″ is less than 10 wt % of the total weight of the multi-phase latex particle 13, 13′, 13″. In other words, the multi-phase latex particle 13, 13′, 13″ includes i) from about 20 wt % to about 80 wt % of heteropolymer(s) 15, 17 having less than 30% of a C6 or greater (meth)acrylate, ii) from about 30 wt % to about 70 wt % of heteropolymer(s) having a glass transition temperature (T_{g}) ranging from 15° C. to 75° C.; iii) greater than 30 wt % of heteropolymer(s) having a glass transition temperature (T_{g}) greater than 75° C.; and iv) less than 10 wt % of aromatic group monomer(s). In some examples, a cumulative percentage of any heteropolymers of the at least two different heteropolymers having a glass transition temperature (Tg) less than 15° C. is less than 20 wt % of the total weight of the multi-phase latex particle composition. In other words, in some examples, the multi-phase latex particle 13, 13′, 13″ includes less than 20 wt % of heteropolymer(s) having a glass transition temperature (T_{g}) less than 15° C.

The hydrophobic or hydrophilic characteristic of any of the heteropolymers 15, 17 may be adjusted by increasing or decreasing the amount of a C6 or greater (meth)acrylate monomer that is present. The term “C6 or greater (meth)acrylate monomer” refers to a monomer that contains an acrylate or methacrylate functional group, where the acrylate or methacrylate functional group is attached, via its single bonded oxygen atom, to a linear or branched alkyl chain or non-aromatic cyclic (ring) compound that has six (6) or more carbon atoms. When the C6 or greater (meth)acrylate monomer(s) make up 30% (by weight) or more of a given heteropolymer 15, 17, the heteropolymer 15, 17 is more hydrophobic than hydrophilic. In contrast, when the C6 or greater (meth)acrylate monomer(s) make up less than 30% (by weight) of a given heteropolymer 15, 17, the heteropolymer 15, 17 is more hydrophilic than hydrophobic.

Examples of the C6 or greater (meth)acrylate monomers are selected from the group consisting of those set forth in Table 1:

TABLE 1

| C6 or | | |
|---|---|---|
| greater | | |
| (meth) | | |
| acrylate | | |
| monomer | Structure | Tg |
| cyclohexyl acrylate (CHA) | 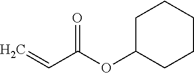 | ~15° C. |
| cyclohexyl metha- crylate (CHMA) | 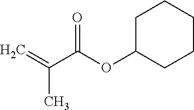 | ~105° C. |
| isobornyl acrylate (iBOA) | 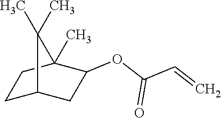 | ~94° C. |
| isobornyl metha- crylate (iBOMA) | 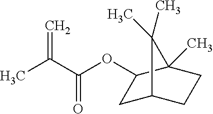 [SMILES: C=C(C)C(=O)OC1CC2CCC1(C)C2(C)C] | ~110° C. |
| 2-ethyl- hexyl acrylate (2-EHA) | 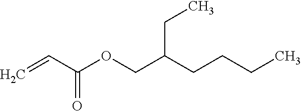 | ~−50° C. |
| 2-ethylhexyl metha- crylate (2-EHMA) | 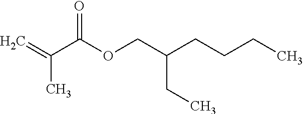 | −10° C. |
| trimethyl- cyclohexyl acrylate (TMCHA) | 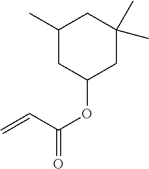 | ~29° C. |
| trimethyl- cyclohexyl metha- crylate (TMCHMA) | 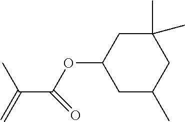 | ~145° C. |
| isodecyl metha- crylate | 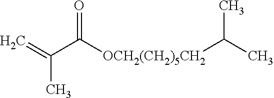 | ~−41° C. |
| lauryl metha- crylate (i.e., dodecyl metha- crylate) | 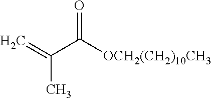 | ~−55° C. |
| iso-tridecyl metha- crylate | 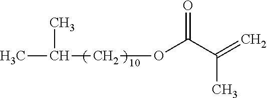 | ~−31° C. |
| stearyl metha- crylate (i.e., octadecyl metha- crylate) | 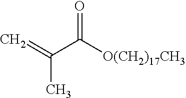 | ~38° C. |
| behenyl metha- crylate | 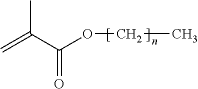 | ~44° C. |
| | where n = 17-21 | |
| dicyclo- pentadienyl acrylate (i.e., dicyclo- pentenyl acrylate) | 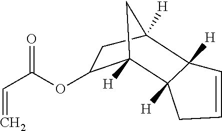 | ~<10° C. |

and combinations of the examples set forth in Table 1.

The C6 or greater (meth)acrylate monomer(s) may be polymerized with functional monomer(s), such as adhesion promoting monomers, acrylonitrile (e.g., to improve chemical resistance), acidic monomers, and/or aromatic monomers, to form some examples of the heteropolymer 15, 17 disclosed herein. In these examples, the heteropolymer 15, 17 includes 30 wt % or more (based on the total weight of the heteropolymer 15, 17) of the C6 or greater (meth)acrylate monomer(s), and thus the heteropolymer 15, 17 is hydrophobic.

Examples of suitable adhesion promoting monomers include n-butyl acryloxy ethyl carbamate (BAEC), monomers including a ureido group, or the like, or combinations thereof. For any single heteropolymer 15, 17, the adhesion promoting monomer may be present in an amount of less than 10 wt % of the total weight of the heteropolymer 15, 17.

Acrylonitrile is an example of a monomer that may be used to improve the chemical resistance of the ink. For any single heteropolymer 15, 17, the acrylonitrile may be present in an amount of less than 10 wt % of the total weight of the heteropolymer 15, 17.

Other monomers, such as diacetone acrylamide (DAAM), may be used that impart chemical resistance through their ability to crosslink with a cross-linker that is added to the ink composition. Dihydrazide crosslinkers may be used, which are capable of reacting with ketone groups in the heteropolymer(s) 15, 17. Monomers that add ketone groups to the heteropolymer 15, 17 include diacetone (meth)acrylamide, diacetone (meth)acrylate, N-(1,1-dimethyl-3-oxobutyl)acrylamide, acetoacetoxyethyl (meth)acrylate, vinyl acetoacetate, crotonaldehyde, 4-vinylbenzaldehyde, (meth)acrolein, vinyl methyl ketone, vinyl ethyl ketone, vinyl butyl ketone, or any other vinyl monomer containing at least one carbonyl. Diamines or hydrazide crosslinkers may also be used, which can crosslink with acetoacetyl groups. Acetoacetyl groups may be incorporated into the heteropolymer(s) 15, 17 using acetoacetoxy alkyl (meth)acrylates, such as 2-acetoacetoxyethyl methacryatate, or acetoacetoxy alkyl (meth)acrylamides. Vinyl silane groups can be incorporated into the heteropolymer(s) 15, 17 and these groups will crosslink with themselves in the presence of moisture. Examples of suitable monomers include triethoxy silane, trimethoxy vinyl silane, and 3-(trimethoxysilyl)propol methacrylate.

Examples of suitable acidic monomers include (meth)acrylic acid, 2-carboxyethyl acrylate, 3-(methacryloyloxy)propionic acid, itaconic acid, citraconic acid, fumaric acid, crotonic acid, maleic acid, or other polymerizable unsaturated carboxylic acids. For any single heteropolymer 15, 17, the acidic monomer may be present in an amount of less than 10 wt % of the total weight of the heteropolymer 15, 17. Some acidic monomers are capable of crosslinking with multifunctional aziridines and/or carbodiimides, and thus can also contribute to improved chemical resistance.

Examples of suitable aromatic monomers include styrene, 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, and combinations thereof. In some examples, styrene is not selected as the aromatic monomer as it can deleteriously affect the performance on non-porous, non-paper-based substrates like polypropylene. For any single heteropolymer 15, 17, the aromatic monomer may be present in an amount of 20 wt % or less of the total weight of one of the heteropolymers 15, 17, with the caveat that the cumulative amount of aromatic monomer(s) the multi-phase latex particle 13, 13′, 13″ is less than 10 wt % of the total weight of the multi-phase latex particles 13, 13′, 13″. In some examples, each of the heteropolymers 15, 17 in the multi-phase latex particles 13, 13′, 13″ excludes aromatic monomer(s).

In other examples, the C6 or greater (meth)acrylate monomer(s) may be polymerized with one or more of the functional monomers and with C5 or fewer (meth)acrylate monomer(s) to form other examples of the heteropolymer 15, 17 disclosed herein. The term “C5 or fewer (meth)acrylate monomer” refers to a monomer that contains an acrylate or methacrylate functional group, where the acrylate or methacrylate functional group is attached, via its single bonded oxygen atom, to a linear or branched alkyl chain or non-aromatic cyclic (ring) compound that has five (5) or fewer carbon atoms. Examples of the C5 or fewer (meth)acrylate monomers are selected from the group consisting of those set forth in Table 2:

TABLE 2

| C5 or fewer | | |
|---|---|---|
| (meth)acrylate | | |
| monomer | Structure | Tg |
| ethyl acrylate (EA) | 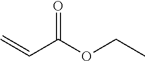 | ~−23° C. |
| ethyl methacrylate (EMA) | 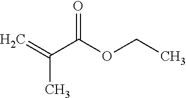 | ~65° C. |
| methyl acrylate (MA) | 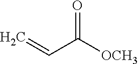 | ~9° C. |
| methyl methacrylate (MMA) | 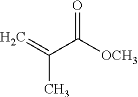 | ~125° C. |
| n-butyl acrylate (n-BA) | 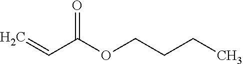 | ~−40° C. |
| n-butyl methacrylate (n-BMA) | 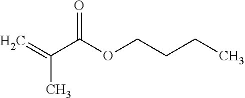 | ~20° C. |
| t-butyl acrylate (t-BA) | 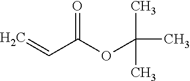 | ~43° C. |
| t-butyl methacrylate (t-BMA) | 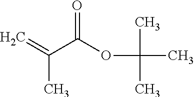 | ~120° C. |
| i-butyl acrylate (i-BA) | 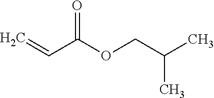 | ~−40° C. |
| i-butyl methacrylate (i-BMA) | 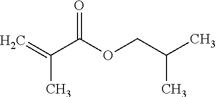 | ~53° C. |
| n-propyl acrylate (n-PA) | 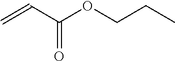 | ~−45° C. |
| n-propyl methacrylate (n-PMA) | 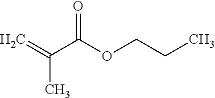 | ~42° C. |
| iso-propyl acrylate (i-PA) | 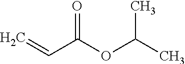 | −8° C. |
| iso-propyl methacrylate (i-PMA) | 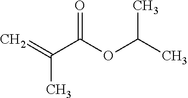 | ~83° C. |
| n-pentyl acrylate | 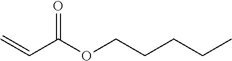 | unknown |
| n-pentyl methacrylate | 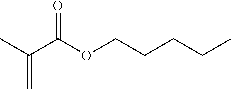 | ~2° C. |
| iso-pentyl methacrylate | 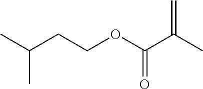 | unknown |

and combinations of the examples set forth in Table 2.

In some of these examples, when it is desirable for the heteropolymer 15 or 14 to be hydrophobic, the C6 or greater (meth)acrylate monomer(s) is/are present in an amount of 30 wt % or more based on the total weight of the heteropolymer 15 or 14 and the C5 or fewer (meth)acrylate monomer(s) is/are present in an amount of 70 wt % or less based on the total weight of the heteropolymer 15 or 14. In one example of the hydrophobic heteropolymer 15, 17, the C6 or greater (meth)acrylate monomer(s) is/are present in an amount ranging from about 60 wt % to about 90 wt % and the C5 or fewer (meth)acrylate monomer(s) is/are present in an amount from greater than 0 wt % to about 40 wt %. In other of these examples, when it is desirable for the heteropolymer 15 or 14 to be hydrophilic, the C6 or greater (meth)acrylate monomer(s) is/are present in an amount of less than 30 wt % based on the total weight of the heteropolymer 15 or 14 and the C5 or fewer (meth)acrylate monomer(s) is/are present in an amount of 60 wt % or more based on the total weight of the heteropolymer 15 or 14. In one example of the hydrophilic heteropolymer 15, 17, the C6 or greater (meth)acrylate monomer(s) is/are present in an amount ranging from about 15 wt % to about 25 wt % and the C5 or fewer (meth)acrylate monomer(s) is/are present in an amount ranging from about 70 wt % to about 80 wt %.

In still other examples, the C5 or fewer (meth)acrylate monomer(s) may be polymerized with the functional monomer(s), such as adhesion promoting monomers, acrylonitrile, diacetone acrylamide or other crosslinkable monomers, acidic monomers, and/or aromatic monomers, to form some other examples of the heteropolymer 15, 17 disclosed herein. In these examples, the heteropolymer 15, 17 does not include the C6 or greater (meth)acrylate monomer(s), and thus the heteropolymer 15, 17 is hydrophilic. In these examples, any of the adhesion promoting monomers, acrylonitrile, the crosslinkable monomers, the acidic monomers, and/or the aromatic monomers may be used.

In the examples disclosed herein, one or more of the heteropolymers 15 or 17 of the multi-phase latex particles 13, 13′, 13″ is hydrophobic and one or more other of the heteropolymers 17 or 15 is hydrophilic. Thus, one or more of the heteropolymers 15 or 17 includes 30% or more of the C6 or greater (meth)acrylate monomer(s), and one or more of the other heteropolymers 17 or 15 includes less than 30% of the C6 or greater (meth)acrylate monomer(s). The hydrophobic heteropolymer(s) 15 or 17 and the hydrophilic heteropolymer(s) 17 or 15 may be present, respectively, in the multi-phase latex particles 13, 13′, 13″ in an amount ranging from about 20 wt % to about 80 wt % of the total weight of the multi-phase latex particles 13, 13′, 13″.

Each heteropolymer 15, 17 in the multi-phase latex particles 13, 13′, 13″ has a glass transition temperature (T_{g}). The selection of each of the monomer(s) used to form the heteropolymer 15, 17 can be used to tune the glass transition temperature (T_{g}) independent of the hydrophobicity/hydrophilicity. The T_{g} of each heteropolymer 15, 17 can be altered by changing the monomer(s) and the amount of the monomer(s) in a given heteropolymer 15, 17. Increasing the amount of monomer(s) with a lower T_{g} can lower the T₉ of the heteropolymer 15, 17, and increasing the amount of monomer(s) with a higher T_{g} can increase the T_{g} of the heteropolymer 15, 17.

The glass transition temperature T_{g} of each heteropolymer 15, 17 may be estimated using the Fox equation (T. G. Fox, Bull. Am. Physics Soc., Volume 1, Issue No. 3, page 123 (1956)) using the percentage and T_{g} of the monomers in the heteropolymer 15, 17.

From about 30 wt % to about 70 wt % of the total weight of the multi-phase latex particle 13, 13′, 13″ is made up of heteropolymer(s) 15, 17 having a T_{g} ranging from 15° C. to 75° C. and greater than 30% of the total weight of the multi-phase latex particle 13, 13′, 13″ is made up of heteropolymer(s) 15, 17 having a T_{g} greater than 75° C., and less than 20% of the total weight of the multi-phase latex particle composition 13, 13′, 13″ is made up of heteropolymer(s) 15, 17 having a T_{g} less than 15° C. In some examples, less than 15% of the heteropolymers 15, 17 in the multi-phase latex particle composition 13, 13′, 13″ has a T₉ less than 15° C. In other examples, none of the heteropolymers 15, 17 in the multi-phase latex particle 13, 13′, 13″ has a T_{g} less than 15° C. In other examples, an additional heteropolymer that has a T_{g} less than 15° C. may be included in the multi-phase latex particle 13, 13′, 13″ as long as the conditions set forth herein pertaining to the percentages of heteropolymers 15, 17 with specific glass transition temperatures is satisfied.

In some examples, the hydrophobic heteropolymers 15 or 17 that include 30% or more of the C6 or greater (meth)acrylate monomer(s) have a moderate T_{g}(e.g., from about 50° to 75° C.) or a high T_{g} (greater than 75° C.), and the hydrophobic heteropolymers 15 or 17 that include less than 30% of the C6 or greater (meth)acrylate monomer(s) have a low T_{g} (e.g., from 15° to about 50° C.), a moderate T_{g}, or a high T_{g}. It is to be understood, however, that any one or more of the hydrophobic heteropolymers 15 or 17 and any one of more of the hydrophilic heteropolymers 17 or 15 may be selected to satisfy the glass transition temperature conditions set forth herein.

As mentioned, FIG. 2A through FIG. 2C schematically illustrate different morphologies of the multi-phase latex particle 13, 13′, 13″. For any of the morphologies, the heteropolymer 15 is physically separated from the heteropolymer 17 within the multi-phase latex particle 13, 13′, 13″. The physical separation of the heteropolymers 15, 17 may manifest itself in a number of different ways. The heteropolymer 15 or 14 may be interdispersed and incompletely coalesced among the heteropolymer 17 or 12, as shown in FIGS. 2A and 2B. In FIG. 2A, the heteropolymer 15 or 14 forms substantially uniform spheres distributed throughout the heteropolymer composition 17 or 15. In FIG. 2B, the heteropolymer 15 or 14 forms a core-like section, where the heteropolymer 17 or 12 substantially surrounds the core-like section and forms random strands/sections that are distributed among the core-like section. In addition to the examples shown in FIGS. 2A and 2B, it is to be understood that any interdispersed and/or incompletely coalesced arrangement of the heteropolymers 15, 17 is contemplated as being suitable for the multi-phase latex particle 13, 13′, 13″ morphology. Alternatively, the heteropolymer 15 may form a core that is located within a continuous or discontinuous shell formed of the heteropolymer 17. Still further, the heteropolymer 17 may form a core that is located within a continuous or discontinuous shell formed of the heteropolymer 15. Both of these morphologies are shown in FIG. 2C. While not shown, some examples of other possible morphologies include the heteropolymers 15, 17 separated into hemispheres, or one of the heteropolymers 15 or 17 present as small nodes at the surface of a sphere of the other of the heteropolymers 17 or 15. As previously mentioned, the morphologies described (whether shown or not shown) are not intended to limit the various physical separations of the heteropolymers 15, 17 that are possible. As such, any physical separation of the heteropolymers 15, 17 within the multi-phase latex particle 13, 13′, 13″ is possible.

In an example, the multi-phase latex particle 13, 13′, 13″ may be formed using multiple streams (e.g., monomer streams) in a reactor. Prior to the addition of any stream, water and a polymerization seed may be added to the reactor. In an example, the polymerization seed is a vinyl polymer, although other seeds may be used. A seed may be a small, pre-formed heteropolymer particle (e.g., formed by a separate emulsion polymerization or other polymerization process) that replaces early particle formation stages by becoming the locus of polymerization. The seed particle(s) grow through additional polymerization in and/or on the seed, and there may be a one to one (1:1) relationship of the number of seeds to the number of final particles that are formed. The use of polymer seeds permits accurate and reproducible particle size control. An initiator may also be added to or included with the water and heteropolymer seed. Examples of suitable initiators include persulfate, such as a metal persulfate or an ammonium persulfate. In some examples, the initiator may be selected from a sodium persulfate, ammonium persulfate, or potassium persulfate. It is to be understood that the initiator dissolved in water may also be added to the reactor throughout the reaction process.

In an example, two streams are concurrently added to the reactor. One of the two steams is a monomer stream including the monomers used to form one of the heteropolymers 15 or 17. In this example, the monomers may be present in an oil-in-water pre-emulsion. Another of the two streams includes an aqueous solution of a copolymerizable surfactant (e.g., surfactants from the HITENOL® AR series or the HITENOL® KH series or the HITENOL® BC series, e.g. HITENOL® AR-10, AR-20, KH-05, KH-10, BC-10, or BC-30). While several examples of surfactants have been provided, it is to be understood that another copolymerizable surfactant may be used, or a non-polymerizable surfactant may be used. These streams may be added over a targeted feed time, and may be allowed to react at a predetermined temperature for a predetermined time. In an example, the targeted feed time is about 105 minutes, the predetermined temperature is about 77° C., and the predetermined time is about 1 hour. While one example has been given, it is to be understood that other feed times, temperatures, and reaction times may be used.

In another example, these two streams (i.e., the monomer stream used to form one of the heteropolymer compositions 15 or 17 and the aqueous surfactant stream) may be combined into an oil-in-water pre-emulsion, and the pre-emulsion may be fed into the reactor as a single stream over the course of the reaction feed time.

In still other examples, the monomers used to form one of the heteropolymers 15 or 17 could be separated into separate monomer feed streams (e.g., a hydrophobic monomer stream and a functional monomer stream). Each of the monomer streams may be paired with a separate aqueous surfactant stream. In this example, each pair (i.e., one of the monomer streams and one of the aqueous surfactant streams) could be fed into the reactor at a particular time (e.g., the first pair of streams followed by the second pair of streams). Alternatively, in this example, each pair could be combined into its own pre-emulsion, and the pre-emulsions may be fed into the reactor sequentially (i.e., one before the other).

In any of the previously described examples (e.g., two streams, a pre-emulsion stream, etc.), another monomer stream is then introduced. This other monomer stream may be an aqueous emulsion including the monomers used to form the other of the heteropolymers 17 or 15. In addition to water and the various monomers, the other monomer stream may also include any example of the copolymerizable surfactant. The other stream may be added over a targeted feed time, and may be allowed to react at a predetermined temperature for a predetermined time. In an example, the targeted feed time is about 195 minutes, the predetermined temperature is about 85° C., and the predetermined time is about 1 hour. While one example has been given, it is to be understood that other feed times, temperatures, and reaction times may be used.

A chain transfer agent may be introduced with the monomer streams. The chain transfer agent may be added to stop a growing chain by transferring the radical activity to the chain transfer agent, which subsequently starts a new polymerizing chain. Examples of suitable chain transfer agents include oil soluble/water insoluble materials, such as mercaptans, e.g., isooctyl thioglycolate, tert-dodecyl mercaptan, etc., or water soluble materials, such as 1-thioglycerol.

The temperatures used during the polymerization processes may vary depending, in part, on the initiator used. For persulfate initiated polymerizations of 5 to 6 hours time, the half-life of the polymerization needs to be taken into account. The reaction temperature determines, in part, the persulfate half-life. In an example involving a persulfate initiator, the reaction temperature ranges from about 68° C. to about 80° C. In another example, the reaction temperature is 70° C.+/−2°.

The overall feed time may be longer or shorter, as desired in order to form the multi-phase latex particle 13, 13′, 13″. In some examples, the feed time may be proportional to the percentage of the heteropolymers 15, 17 that are to be formed. For example, with a 5 hour feed time and a target composition for the multi-phase latex particle 13, 13′, 13″ including about 35 wt % of the heteropolymer 15 and about 65 wt % of the heteropolymer 17, the monomers for the heteropolymer 15 may be fed for 35% of the 5 hour period (about 105 minutes) and the monomers for the heteropolymer 17 may be fed for 65% of the 5 hour period (about 195 minutes). It is to be understood that other feed times may be used that are unrelated to the percentage of the heteropolymers 15, 17 in the multi-phase latex particle 13, 13′, 13″.

In addition to the percentage of total monomer in the feeds, the respective polymerization rates (propagation rate coefficients) may be taken into account when setting the feed rates, to allow control over the polymerization kinetics.

The reaction product includes particles of the multi-phase latex particle 13, 13′, 13″ in an aqueous emulsion. As such, these particles may be referred to as latex particles. The particle size (i.e., average diameter) of the latex particles may range from about 0.06 μm (about 60 nm) to about 0.4 μm (about 400 nm). In another example, the particle size of the latex particles may range from about 0.1 μm to about 0.3 μm. In some examples, the latex particles within a distribution of the particles can have a median diameter (D50) ranging from about 130 nm to about 230 nm. In an example, the median value may be weighted by volume.

In an example, the aqueous emulsion may include from about 20% solids to about 60% solids (e.g., from about 40% solids to about 50% solids), based on the total weight of the aqueous emulsion. The viscosity of the aqueous emulsion may be less than 50 cps, or less than 20 cps (when measured at 25° C. and 50 rpm with a Brookfield viscometer).

With any of these polymerization processes, the heteropolymer 15 may be formed first, followed by the heteropolymer 17, which may result in the heteropolymer 15 forming the substantially uniform spheres of FIG. 2A, the core-like section of FIG. 2B, or the core of FIG. 2C. Alternatively, the heteropolymer 17 may be formed first, followed by the heteropolymer 15, which may result in the heteropolymer 17 forming the substantially uniform spheres of FIG. 2A, the core-like section of FIG. 2B, or the core of FIG. 2C. It is to be understood that the feed order influences the morphology, but does not guarantee the formation of a particular morphology.

Following the polymerization of the heteropolymer 15 and/or of the heteropolymer 17, a cross-linker may be added to promote crosslinking of a crosslinkable monomer (e.g., DAAM, acetoacetoxy ethyl methacrylate, etc.) used in the formation of the heteropolymer 15 and/or 17. Examples of suitable cross-linkers include isophthalic dihydrazide (IPDH), adipic dihydrazide (ADH), oxalic dihydrazide (ODH), succinic dihydrazide, malonic dihydrazide, sebacic dihydrazide, maleic dihydrazide, fumaric dihydrazide, itaconic dihydrazide, terephthalic dihydrazide, and the like. Multifunctional dihydrazides containing three or more hydrazide groups may also be used. Another suitable cross-linkers (e.g., for crosslinking acid groups) includes the commercially available aziridine crosslinker, PZ-33 Polyfunctional Aziridine from Covestro. A diamine may be used to crosslink acetoacetyl groups. In some examples of the multi-phase latex particle 15, 17, at least one of the at least two different heteropolymers 15, 17 is crosslinked.

The following are some specific examples of the heteropolymers 15, 17 that can be combined to form examples of the multi-phase latex particles 13, 13′, 13″ disclosed herein.

In a first example, the first heteropolymer 15 of the at least two different heteropolymers 15, 17 includes less than 30% of the C6 or greater (meth)acrylate monomer and has the Tg ranging from 15° C. to 75° C.; and the second heteropolymer 17 of the at least two different heteropolymers 15, 17 includes greater than 30% of the C6 or greater (meth)acrylate monomer and has the Tg greater than 75° C. In this first example, the first heteropolymer 15 is hydrophilic with a low to moderate T_{g} and the second heteropolymer 17 is hydrophobic with a high T_{g}. In this first example, the first heteropolymer 15 may make up from about 50 wt % to about 70 wt % of the total weight of the multi-phase latex particle 13, 13′, 13″, and the second heteropolymer 17 may make up from greater than 30 wt % to about 50 wt % of the total weight of the multi-phase latex particle 13, 13′, 13″. In this first example, the first heteropolymer 15 may consist of a C5 or less (meth)acrylate monomer, a first adhesion promoting monomer, a first acidic monomer, and a first polymerizable surfactant; and the second heteropolymer 17 may consist of the C6 or greater (meth)acrylate monomer, a second adhesion promoting monomer, a second acidic monomer, a second polymerizable surfactant, the aromatic group monomer, and optionally a chain transfer agent. In this example, the C5 or less (meth)acrylate monomer (of heteropolymer 15) is selected from the group consisting of methyl (meth)acrylate, n-butyl (meth)acrylate, t-butyl (meth)acrylate, i-butyl (meth)acrylate, and combinations thereof; and the C6 or greater (meth)acrylate monomer (of heteropolymer 17) is selected from the group consisting of cyclohexyl (meth)acrylate, isobornyl (meth)acrylate, 2-ethylhexacrylate, and combinations thereof.

In this first example, the heteropolymer 15 forms the substantially uniform spheres of FIG. 2A, the core-like section of FIG. 2B, or the core of FIG. 2C, while the heteropolymer 17 forms the shell.

Table 3 illustrates two examples of this first example of the multi-phase latex particles 13, 13′, 13″, and Table 4 illustrates example characteristics of these two examples. The weight percentages of the various components are within the ranges set forth herein for the heteropolymers 15, 17.

TABLE 3

| | | multi- | multi- |
|---|---|---|---|
| | | phase latex | phase latex |
| | Component | particle #1 | particle #2 |
| Heteropolymer | C5 or less | n-butyl acrylate | n-butyl acrylate |
| 15 | (meth)acrylate | methyl | methyl |
| | monomer(s) | methacrylate | methacrylate |
| | Adhesion | Diacetone | Diacetone |
| | promoting | acrylamide | acrylamide |
| | monomer | | n-butyl |
| | | | acryloxy ethyl |
| | | | carbamate |
| | Acidic monomer | Methacrylic acid | Methacrylic acid |
| | Polymerizable | HITENOL ® | HITENOL ® |
| | surfactant | AR series | AR series |
| Heteropolymer | C6 or greater | cyclohexyl | cyclohexyl |
| 17 | (meth)acrylate | methacrylate | methacrylate |
| | monomer | | |
| | Adhesion | n-butyl | n-butyl |
| | promoting | acryloxy ethyl | acryloxy ethyl |
| | monomer(s) | carbamate | carbamate |
| | | Diacetone | Diacetone |
| | | acrylamide | acrylamide |
| | Acidic monomer | Methacrylic acid | Methacrylic acid |
| | Polymerizable | HITENOL ® | HITENOL ® |
| | surfactant | AR series | AR series |
| | Aromatic | Phenoxyethyl | Phenoxyethyl |
| | monomer | methacrylate | methacrylate |
| | Chain transfer | Isooctyl | N/A |
| | agent | thioglycolate | |

TABLE 4

| | | multi- | multi- |
|---|---|---|---|
| | | phase latex | phase latex |
| | Characteristic | particle #1A | particle #1B |
| Heteropolymer | T_{g} | 55-60 | 55-60 |
| 15 | % of total multi-phase | 65 | 65 |
| | latex particle | | |
| | Hydrophilic/ | Hydrophilic | Hydrophilic |
| | Hydrophobic | | |
| Heteropolymer | T_{g} | 90-95 | 90-95 |
| 17 | % of total multi-phase | 35 | 35 |
| | latex particle | | |
| | Hydrophilic/ | Hydrophobic | Hydrophobic |
| | Hydrophobic | | |

In a second example, the first heteropolymer 15 of the at least two different heteropolymers 15, 17 includes greater than 30% of the C6 or greater (meth)acrylate monomer and has the Tg ranging from 15° C. to 75° C.; and the second heteropolymer 17 of the at least two different heteropolymers 15, 17 includes less than 30% of the C6 or greater (meth)acrylate monomer and has the Tg greater than 75° C. In this second example, the first heteropolymer 15 is hydrophobic with a low to moderate T_{g} and the second heteropolymer 17 is hydrophilic with a high T_{g}. In this second example, the first heteropolymer 15 may make up from about 30 wt % to about 45 wt % of the total weight of the multi-phase latex particle 13, 13′, 13″, and the second heteropolymer 17 may make up from about 55 wt % to about 70 wt % of the total weight of the multi-phase latex particle 13, 13′, 13″. In this second example, the first heteropolymer 15 may consist of the C6 or greater (meth)acrylate monomer, at least one adhesion promoting monomer, a first acidic monomer, and a first polymerizable surfactant; and the second heteropolymer may consist of a C5 or less (meth)acrylate monomer, the C6 or greater (meth)acrylate monomer, the at least one adhesion promoting monomer, a second acidic monomer, and a second polymerizable surfactant. In this example, the C6 or greater (meth)acrylate monomer is selected from the group consisting of cyclohexyl (meth)acrylate, isobornyl (meth)acrylate, 2-ethylhexacrylate, and combinations thereof; and the C5 or less (meth)acrylate monomer is selected from the group consisting of methyl (meth)acrylate, n-butyl (meth)acrylate, t-butyl (meth)acrylate, i-butyl (meth)acrylate, and combinations thereof.

In this second example, the heteropolymer 15 forms the substantially uniform spheres of FIG. 2A, the core-like section of FIG. 2B, or the core of FIG. 2C, while the heteropolymer 17 forms the shell.

Table 5 illustrates one example of this second example of the multi-phase latex particles 13, 13′, 13″, and Table 6 illustrates example characteristics of this example. The weight percentages of the various components are within the ranges set forth herein for the heteropolymers 15, 17.

TABLE 5

| | | multi- | multi- |
|---|---|---|---|
| | | phase latex | phase latex |
| | Component | particle #2A | particle #2B |
| Heteropolymer | C6 or | cyclohexyl | cyclohexyl |
| 15 | greater | acrylate | acrylate |
| | (meth)acrylate | cyclohexyl | cyclohexyl |
| | monomer(s) | methacrylate | methacrylate |
| | Adhesion | Diacetone | Diacetone |
| | promoting | acrylamide | acrylamide |
| | monomer(s) | n-butyl | n-butyl |
| | | acryloxy ethyl | acryloxy ethyl |
| | | carbamate | carbamate |
| | Acidic monomer | Methacrylic acid | Methacrylic acid |
| | Polymerizable | HITENOL ® | HITENOL ® |
| | surfactant | AR series | AR series |
| Heteropolymer | C5 or less | n-butyl acrylate | n-butyl acrylate |
| 17 | (meth)acrylate | methyl | methyl |
| | monomer(s) | methacrylate | methacrylate |
| | C6 or greater | cyclohexyl | cyclohexyl |
| | (meth)acrylate | (meth)acrylate | (meth)acrylate |
| | monomer(s) | | |
| | Adhesion | Diacetone | Diacetone |
| | promoting | acrylamide | acrylamide |
| | monomer | | |
| | Acidic monomer | Methacrylic acid | Methacrylic acid |
| | Polymerizable | HITENOL ® | HITENOL ® |
| | surfactant | AR series | AR series |
| | Aromatic | N/A | Phenoxyethyl |
| | monomer | | methacrylate |

TABLE 6

| | | multi- | multi- |
|---|---|---|---|
| | | phase latex | phase latex |
| | Characteristic | particle #2A | particle #2B |
| Heteropolymer | T_{g} | 55-60 | 55-60 |
| 15 | % of total | 35 | 35 |
| | multi-phase | | |
| | latex particle | | |
| | Hydrophilic/ | Hydrophobic | Hydrophobic |
| | Hydrophobic | | |
| Heteropolymer | T_{g} | 90-95 | 90-95 |
| 17 | % of total | 65 | 65 |
| | multi-phase | | |
| | latex particle | | |
| | Hydrophilic/ | Hydrophilic | Hydrophilic |
| | Hydrophobic | | |

In an example, the latex particles 13, 13′, 13″ are present in an amount ranging from about 5 wt % active to about 20 wt % active of a total weight of the inkjet ink 14. When the latex particles 13, 13′, 13″ are incorporated into the inkjet ink 14 as part of a dispersion (e.g., which also includes water), it is to be understood that these percentages account for the weight percent of solid latex particles 13, 13′, 13″ in the inkjet ink 14, and does not account for the total weight percent of the dispersion itself that may be incorporated in the inkjet ink 14.

The inkjet ink 14 also includes the aqueous vehicle (i.e., the second aqueous vehicle). The vehicle of the inkjet ink 14 is an aqueous vehicle because it includes some water. In some examples, the aqueous vehicle may be a water-based vehicle, where water is the main vehicle component, i.e., is present at 50 wt % or higher. The water-based vehicle is particularly suitable when the inkjet ink 14 is to be jetted via thermal inkjet printing. In other examples, the aqueous vehicle may be a solvent-based vehicle, where a solvent or a mixture of co-solvents is the main vehicle component, i.e., is present at 50 wt % or higher, and water is included as a minor vehicle component, i.e., less than 50 wt %. The solvent-based vehicle is particularly suitable when the inkjet ink 14 is to be jetted via piezoelectric inkjet printing.

In some examples, the inkjet ink 14 includes water in an amount of at least about 20 wt %, for example, at least about 30 wt %, or at least about 40 wt %, or at least about 50 wt %, by total weight of the inkjet ink 14. In some examples, the inkjet ink 14 includes up to about 80 wt % water, for example up to about 75 wt %, up to about 60 wt %, or up to about 55 wt %, by total weight of the inkjet ink 14. In some examples, the inkjet ink 14 includes water in an amount ranging from about 20 wt % to about 85 wt % by total weight of the inkjet ink 14.

The inkjet ink 14 also includes a co-solvent or a blend of co-solvents. In some examples, the inkjet ink 14 includes the co-solvent(s) in an amount of at least about 1 wt %, for example at least about 5 wt %, or at least about 10 wt %, by total weight of the inkjet ink 14. In some examples, the inkjet ink 14 includes the co-solvent(s) in an amount up to about 50 wt %, for example up to about 40 wt %, or up to about 35 wt % by total weight of the inkjet ink 14. In some examples, inkjet ink 14 includes the co-solvent(s) in an amount ranging from about 1 wt % to about 50 wt % by total weight of the inkjet ink 14. In still other examples, the inkjet ink 14 includes the co-solvent(s) in an amount ranging from about 50 wt % to about 80 wt % by total weight of the inkjet ink 14.

In some examples, the co-solvent is a blend including a solvent having a boiling point ranging from about 170° C. to about 215° C. and a solvent having a boiling point of about 220° C. or more. The solvent having a boiling point ranging from about 170° C. to about 215° C. may itself be a blend of solvents, where each solvent of the blend has a boiling point ranging about 170° C. to about 215° C. The solvent having a boiling point of about 220° C. or more may also be a blend of solvents, where each solvent of the blend of solvents has a boiling point of about 220° C. or more. When the blend including a solvent having a boiling point ranging from about 170° C. to about 215° C. and a solvent having a boiling point of about 220° C. or more is used, the inkjet ink 14 may include from about 10 wt % to about 40 wt % by total weight of the inkjet ink 14 of the solvent having the boiling point in the range of about 170° C. to about 215° C. and from about 0.1 wt % to about 8 wt % by total weight of the inkjet ink 14 of the solvent having the boiling point of about 220° C. or more.

In some other examples, the co-solvent is a blend including a solvent having a boiling point ranging from about 170° C. to about 215° C. and a solvent having a boiling point of ranging from about 220° C. to about 285° C. In these examples, the inkjet ink 14 may include from about 10 wt % to about 40 wt % by total weight of the inkjet ink 14 of the solvent having the boiling point in the range of about 170° C. to about 215° C. and/or from about 0.5 wt % to about 8 wt % of the solvent having the boiling point in the range of about 220° C. to about 285° C.

Some examples of the aqueous vehicle include the solvent having a boiling point ranging from about 170° C. to about 215° C. In an example, this solvent has a boiling point ranging from about 180° C. to about 215° C. In some examples, this solvent is selected from an aliphatic alcohol, for example a primary aliphatic alcohol, a secondary aliphatic alcohol, or a tertiary aliphatic alcohol. The aliphatic alcohol may be a diol. In some examples, this solvent is an aliphatic alcohol (specifically a diol) containing 10 carbons or less, for example 8 carbons or less, or 6 carbons or less.

Specific examples of the solvent having a boiling point ranging from about 170° C. to about 215° C. may be selected from the group consisting of 1,2-propanediol, 1,2-butanediol, ethylene glycol, 2-methyl-2,4-pentanediol, 1,3-butanediol, 2-methyl-1,3-propanediol, 1,3-propanediol, and combinations thereof. In some examples, the solvent having a boiling point ranging from about 170° C. to about 215° C. is selected from the group consisting of 1,2-propanediol, 1,2-butanediol, ethylene glycol, 2-methyl-2,4-pentanediol, 1,3-butanediol, and combinations thereof. In some other examples, the solvent is 1,2-butanediol. The boiling points of 1,2-propanediol, 1,2-butanediol, ethylene glycol, 2-methyl-2,4-pentanediol, 1,3-butanediol, 2-methyl-1,3-propanediol and 1,3-propanediol are listed in Table 7 below.

TABLE 7

| | Boiling point |
|---|---|
| Solvent | (° C.) |
| propylene glycol (1,2-propanediol) | 188 |
| 1,2-butanediol | 194 |
| ethylene glycol | 196 |
| 2-methyl-2,4-pentanediol (hexylene glycol) | 198 |
| 1,3-butanediol | 203 |
| 2-methyl-1,3-propanediol (MPdiol) | 213 |
| 1,3-propanediol | 214 |

In some examples, the inkjet ink 14 includes at least about 5 wt % (by total weight of the inkjet ink 14) of the solvent having a boiling point ranging from about 170° C. to about 215° C. In some examples, the inkjet ink 14 includes up to about 40 wt % (by total weight of the inkjet ink 14) of the solvent having a boiling point ranging from about 170° C. to about 215° C.

Some examples of the aqueous vehicle include the solvent having a boiling point of about 220° C. or more. In some instance, this solvent may be defined as having a boiling point ranging from about 220° C. to about 285° C. Blends of these solvents may also be used.

The solvent having the boiling point ranging from about 220° C. to about 285° C. may be selected from alcohols (including aliphatic alcohols and aromatic alcohols), esters, glycol ethers, di- and tri-alkylene glycols, amides, lactams and sulfones. In some examples, this solvent is selected from aliphatic alcohols (including primary, secondary and tertiary aliphatic alcohols, including diols), aromatic alcohols, esters, alkylene glycol alkyl ethers (including di-, tri- and tetra-alkylene glycol alkyl ethers), glycol aryl ethers (such as alkylene glycol aryl ethers, including di- and tri-alkylene glycol aryl ethers), di- and tri-alkylene glycols, lactams (such as 2-pyrrolidinone), and sulfones (such as sulfolane or other cyclic sulfones). In some examples, the aliphatic alcohols, esters, glycol alkyl ethers, and glycol aryl ethers may have 20 carbon atoms or less (e.g., 12 carbons or less, 10 carbons or less, etc.).

Specific examples of the solvent having the boiling point ranging from about 220° C. to about 285° C. may be selected from the group consisting of ethylene glycol 2-ethylhexyl ether, dipropylene glycol n-butyl ether, diethylene glycol n-butyl ether, propylene glycol phenyl ether, 2-pyrrolidinone, tripropylene glycol methyl ether, 2,2,4-trimethyl-1,3-pentanediol monoisobutyrate, tripropylene glycol n-propyl ether, tripropylene glycol n-butyl ether, tetraethylene glycol dimethyl ether, and dipropylene glycol phenyl ether. In some examples, the solvent having the boiling point ranging from about 220° C. to about 285° C. may be selected from the group consisting of 2-pyrrolidinone, tripropylene glycol methyl ether, and tripropylene glycol n-butyl ether.

The boiling points of some examples of the solvent having the boiling point ranging from about 220° C. to about 285° C. are listed in Table 8 below.

TABLE 8

| | Boiling point |
|---|---|
| Solvent | (° C.) |
| ethylene glycol 2-ethylhexyl ether (Eastman EEH) | 229 |
| dipropylene glycol n-butyl ether (DOWANOL ™ DPnB) | 230 |
| diethylene glycol n-butyl ether (Butyl Carbitol) | 230 |
| propylene glycol phenyl ether (DOWANOL ™ PPh) | 243 |
| 2-pyrrolidinone | 245 |
| tripropylene glycol methyl ether (DOWANOL ™ TPM) | 245 |
| 2,2,4-trimethyl-1,3-pentanediol monoisobutyrate | 255-261.5 |
| (TEXANOL ™) | |
| tripropylene glycol n-propyl ether | 261 |
| tripropylene glycol n-butyl ether (DOWANOL ™ TPnB) | 274 |
| tetraethylene glycol dimethyl ether (tetraglyme) | 275 |
| dipropylene glycol phenyl ether (DOWANOL ™ DiPPh) | 280 |

In some examples, the inkjet ink 14 includes at least about 0.1 wt % (by total weight of the inkjet ink 14) of the solvent having a boiling point ranging from about 220° C. to about 285° C. In some examples, the inkjet ink 14 includes up to about 8 wt % (by total weight of the inkjet ink 14) of the solvent having a boiling point ranging from about 220° C. to about 285° C.

The aqueous vehicle may also include a variety of additional components suitable for an inkjet ink composition. These additional components may include surfactants, buffers, anti-microbial agents, sequestering agents, anti-kogation agents (e.g., for thermal inkjet inks), and/or humectants.

Examples of suitable surfactants that may be included in the aqueous vehicle of the inkjet ink 14 include siloxane-based gemini surfactants, alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, and the like. Some specific examples of non-ionic surfactants include the following from Evonik: SURFYNOL® SEF (a self-emulsifiable, wetting agent based on acetylenic diol chemistry), SURFYNOL® 440 or SURFYNOL® CT-111 (non-ionic ethoxylated low-foam wetting agents), SURFYNOL® 420 (non-ionic ethoxylated wetting agent and molecular defoamer), SURFYNOL® 104E (non-ionic wetting agents and molecular defoamer), TEGO® Twin 4000 (siloxane-based gemini surfactant), and TEGO® Wet 510 (organic surfactant). Other specific examples of non-ionic surfactants include the following from The Dow Chemical Company: TERGITOL™ TMN-6, TERGITOL™ 15-S-7, TERGITOL™ 15-S-9, TERGITOL™ 15-S-12 (secondary alcohol ethoxylates). Still other suitable non-ionic surfactants are available from Chemours, including the CAPSTONE® fluorosurfactants, such as CAPSTONE® FS-35 (a non-ionic fluorosurfactant).

Whether a single surfactant is used or a combination of surfactants is used, the total amount of surfactant(s) in the inkjet ink 14 may range from about 0.01 wt % active to about 3 wt % active based on the total weight of the inkjet ink 14. In an example, the total amount of surfactant(s) in the inkjet ink 14 may be about 0.7 wt % active based on the total weight of the inkjet ink 14.

Some examples of the aqueous vehicle of the inkjet ink 14 include a buffer. The buffer may be TRIS (tris(hydroxymethyl)aminomethane or TRIZMA®), TRIS or TRIZMA® hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of buffer(s) in the inkjet ink 14 ranges from about 0.01 wt % active to about 3 wt % active (based on the total weight of the inkjet ink 14).

The aqueous vehicle of the inkjet ink 14 may also include an anti-microbial agent. Examples of suitable additional anti-microbial agents include the NUOSEPT® series (Ashland Inc.), UCARCIDE™ or KORDEK™ or ROCIMA™ (The Dow Chemical Company), the PROXEL® series (Arch Chemicals), ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), ACTICIDE® MV (a blend of 5-chloro-2-methyl-4-isothiazolin-3-one (CIT or CMIT) and MIT) (Thor Chemicals), AXIDE™ (Planet Chemical), NIPACIDE™ (Clariant), other blends of CIT or CMIT and MIT under the tradename KATHON™ (The Dow Chemical Company), and combinations thereof.

In an example, the total amount of anti-microbial agent(s) in the inkjet ink 14 ranges from about 0.01 wt % active to about 0.05 wt % active (based on the total weight of the inkjet ink 14). In another example, the total amount of additional anti-microbial agent(s) in the inkjet ink 14 is about 0.04 wt % active (based on the total weight of the inkjet ink 14).

Chelating agents (or sequestering agents) may be included in the aqueous vehicle of the inkjet ink 14 to eliminate the deleterious effects of heavy metal impurities. Examples of suitable chelating agents are selected from the group consisting of methylglycinediacetic acid, trisodium salt (e.g., TRILON® M from BASF Corp.); 4,5-dihydroxy-1,3-benzenedisulfonic acid disodium salt monohydrate; ethylenediaminetetraacetic acid (EDTA); hexamethylenediamine tetra(methylene phosphonic acid), potassium salt; sodium salt of polyacrylic acid; and combinations thereof.

Whether a single chelating agent is used or a combination of chelating agents is used, the total amount of chelating agent(s) in the inkjet ink 14 may range from greater than 0 wt % active to about 0.5 wt % active based on the total weight of the inkjet ink 14. In an example, the chelating agent is present in an amount ranging from about 0.05 wt % active to about 0.2 wt % active based on the total weight of inkjet ink 14. In another example, the chelating agent(s) is/are present in the inkjet ink 14 in an amount of about 0.05 wt % active (based on the total weight of the inkjet ink 14). In an example, the chelating agent may be present in an amount as low as 400 ppm.

An anti-kogation agent may also be included in the aqueous vehicle when the inkjet ink 14 is a thermal inkjet ink. Kogation refers to the deposit of dried ink solids on a heating element of a thermal inkjet printhead. Anti-kogation agent(s) is/are included to assist in preventing the buildup of kogation. In some examples, the anti-kogation agent may improve the jettability of the thermal inkjet ink. Examples of suitable anti-kogation agents include oleth-3-phosphate (commercially available as CRODAFOS™ 03A or CRODAFOS™ N-3A) or dextran 500 k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The anti-kogation agent may be present in the thermal inkjet ink in an amount ranging from about 0.1 wt % active to about 1.5 wt % active, based on the total weight of the inkjet ink 14. In an example, the anti-kogation agent is present in an amount of about 0.5 wt % active, based on the total weight of the inkjet ink 14.

The aqueous vehicle of the inkjet ink 14 may also include a humectant. An example of a suitable humectant is ethoxylated glycerin having the following formula:

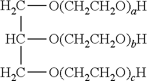

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the inkjet ink 14 ranges from about 3 wt % active to about 10 wt % active, based on the total weight of the inkjet ink 14.

To form examples of the inkjet ink 14, the aqueous vehicle, the aqueous emulsion including the latex particles 13, 13′, 13″, and the pigment dispersion are combined. In some examples, additional water or other main solvent may be added to the inkjet ink 14.

### Non-Porous Substrate

The inkjet fluid set 10 may be used to generate prints on non-porous, non-paper-based media. Non-paper-based media does not include cellulose fibers, but rather is made up of synthetic polymeric materials. In some examples, the synthetic polymeric materials are fibers, or extruded or cast films. Rigid media may be thicker than flexible media. Rigid media may contain compounded stiffeners or fillers, or may be engineered composites. In an example, the non-porous, non-paper-based substrate/medium 18 has a surface energy lower than 50 dynes/cm.

The non-porous, non-paper-based medium 18 may be flexible or rigid.

As used herein, the term “flexible non-porous, non-paper-based media” refers to a medium that can be fed from a roll without cracking, breaking, ripping, etc. In an example, the flexible non-porous media may be fed from one media roll through the printer to another media roll (e.g., a take-up roll). Examples of the flexible non-porous, non-paper-based media include self-adhesive vinyl (SAV, which is a plasticized poly(vinyl chloride) (PVC) often used in vehicle wraps, examples of which include 3M IJ180c Controltac cast SAV, Avery MPI 1005 cast SAV, and Avery MPI 2903 calendared SAV), polyethylene terephthalate (PET), synthetic paper (also known as “plastic paper”, which includes compounded polypropylene, examples of which are commercially available from Yupo Corp.), etc.

Also as used herein, the term “rigid non-porous, non-paper-based media” refers to a medium that is commonly pre-cut to a size that may then be fed through a printer or that may rest on a flat supporting structure or bed while a printing module scans across the surface while applying ink by a digital means (e.g., pen or inkjet module). Rigid media may show indications of flexibility, but generally cannot be fed from a roll without cracking, breaking, ripping, etc. Examples of the rigid non-porous, non-paper-based media include polypropylene, acrylics, polycarbonate, poly(methyl methacrylate), coated aluminum with a polyethylene (PE) core, wood, glass, etc. Examples of polypropylene include INTEPRO® Fluted Polypropylene, COROPLAST® Corrugated Plastic Sheets, Correx Fluted Display Board, and BIPRINT® corrugated sheets.

### Printing Method

The inkjet fluid set 10 and the inkjet printing kit 20 disclosed herein may be used in a printing method. An example of the printing method involves inkjet printing the pre-treatment fluid 12 onto a non-porous, non-paper-based substrate 18, the pre-treatment fluid 12 including a first aqueous vehicle and a water resistance and adhesion promoting cationic polymer dissolved or dispersed in the first aqueous vehicle; and inkjet printing an inkjet ink 14 on at least a portion of the pre-treatment fluid 12, the inkjet ink 14 including a second aqueous vehicle, a pigment dispersed throughout the second aqueous vehicle, and multi-phase latex particles 13, 13′, 13″ dispersed throughout the second aqueous vehicle, each of the multi-phase latex particles 13, 13′, 13″ including at least two different heteropolymers 15, 17 defining at least two different phases of the multi-phase latex particle 13, 13′, 13″.

Both the pre-treatment fluid 12 and the inkjet ink 14 may be digitally printed using piezoelectric inkjet printing or thermal inkjet printing. In an example, the inkjet ink 14 is printed on the at least the portion of the pre-treatment fluid 12 while the pre-treatment fluid 12 is wet. Alternatively, the pre-treatment fluid 12 may undergo some degree of drying before the inkjet ink 14 is printed thereon.

The printing method generates a pre-treatment layer on the non-porous, non-paper-based substrate 18 and an ink layer on the pre-treatment layer. In some examples, the method of printing further includes curing the pre-treatment layer and the ink layer. Thermal curing causes the latex particles 13, 13′, 13″ in the printed inkjet ink 14 to form a polymeric film on the surface of the non-porous, non-paper-based substrate 18. Moreover, the heat generated during thermal curing may be sufficient to initiate crosslinking or other interactions involving the cationic polymer in the printed pre-treatment fluid 12 that improve the adhesion between the printed pre-treatment fluid 12 and the non-porous, non-paper-based substrate 18.

In order for the latex particles 13, 13′, 13″ to be cured, water may first be evaporated from the pre-treatment layer and the ink layer, and then any one or more of the co-solvents may be at least partially evaporated from the pre-treatment layer and the ink layer. Evaporation enables the latex particles 13, 13′, 13″ to come into close contact with each other. Once the latex particles 13, 13′, 13″ come into close contact (due to the at least partial evaporation of water and co-solvent(s)), the latex particles 13, 13′, 13″ may coalesce by the intermingling of polymer chains between adjacent latex particles 13, 13′, 13″ to cure the latex particles 13, 13′, 13″ and form a polymeric film. In order for the latex particles 13, 13′, 13″ to be cured, the temperature of curing should be above the minimum film formation temperature (MFFT) of the applied ink layer. Pigment particles, where present, remain in the ink layer and are embedded within the polymeric film upon curing of the latex particles 13, 13′, 13″.

Water is evaporated before the co-solvent(s) are at least partially removed (evaporated), as water has a higher volatility (e.g., lower boiling point) than the co-solvent(s).

In examples where the aqueous vehicle (of the pre-treatment layer and/or the ink layer) includes the solvent having a boiling point ranging from about 170° C. to about 215° C. and the solvent having a boiling point ranging from about 220° C. to about 285° C., the solvent having the lower boiling point is evaporated, or at least partially evaporated, before the solvent having the higher boiling point, again due to the higher volatility of the solvent having the lower boiling point. The solvent having the higher boiling point remains in the pre-treatment layer and/or the ink layer after the water has been evaporated and the solvent with the lower boiling point has been at least partially evaporated.

The inclusion of the solvent having a boiling point of less than about 215° C. in the inkjet ink 14 allows for fast drying of the inkjet ink 14 to enable high throughput through the printing system. The presence of the higher boiling point solvent(s) in the inkjet ink 14, which remain in the ink layer after evaporation of the water and at least partial evaporation of the solvent having a boiling point of less than about 215° C., ensures that the MFFT of the ink layer remains lowered during the curing process.

Evaporation may be facilitated in a printing system by providing heat and/or airflow. Heating may be conductive, radiative, or convective heating. Airflow may include parallel or impinging airflow. In some examples, heating the ink layer to evaporate water and at least a portion of the co-solvent(s) includes heating the ink layer to a temperature greater than the MFFT and such that the temperature of the non-porous, non-paper-based substrate is maintained below a temperature at which deformation (e.g., warping) of the non-porous, non-paper-based substrate 18 occurs. For example, heating the ink layer may be accomplished such that the non-porous, non-paper-based substrate 18 reaches a temperature of less than about 70° C., for example about 65° C. or less.

In some examples, curing the latex particles 13, 13′, 13″ includes evaporating substantially all of the water from the ink layer, for example evaporating at least about 95 wt %, or at least about 99 wt %, or at least about 99.5 wt % of the water present in the inkjet ink 14 printed as the ink layer. In some examples, curing the latex particles 13, 13′, 13″ includes evaporating all of the water from the ink layer so that no water remains in the ink layer. Similar amounts of water may also be evaporated from the pre-treatment layer.

As previously mentioned, curing the latex particles may also involve evaporating at least a portion of the co-solvent(s). In an example, a major amount of the co-solvent(s) of the inkjet ink 14 printed as the ink layer may be evaporated from the ink layer. In some examples, evaporating at least a portion of the co-solvent(s) includes evaporating at least about 80 wt %, or at least about 90 wt %, or at least about 99 wt % of the solvent having a boiling point ranging from about 170° C. to about 215° C. present in the inkjet ink 14 printed as the ink layer. Similar amounts of co-solvent(s) may also be evaporated from the pre-treatment layer. In some instances, all of the solvents are evaporated upon completion of curing.

In other examples, the solvent having a boiling point of about 220° C. or more is not evaporated from the ink layer during curing of the latex particles 13, 13′, 13″. In some examples, at least a portion of the solvent having a boiling point of about 220° C. remains in the ink layer after curing of the latex polymer.

Referring now to FIG. 3, a schematic diagram of a printing system 21 including an inkjet printer 22 in a printing zone 24 of the printing system 21 and a drier 26 positioned in a curing zone 28 of the printing system 21. A non-porous, non-paper-based substrate 18 may be transported through the printing system 21 along the path shown by arrow A such that the non-porous, non-paper-based substrate 18 is first fed to the printing zone 24. In the printing zone 24, an example of the pre-treatment fluid 12 and the inkjet ink 14 are sequentially inkjet printed onto the non-porous substrate 18 the inkjet printer 22 to form, respectively, a pre-treatment layer 23 on the non-porous, non-paper-based substrate 18 and an ink layer 25 on the pre-treatment layer 23. The printing of the pre-treatment fluid 12 and the inkjet ink 14 are respectively represented by arrows B and C. The pre-treatment and ink layers 23, 25 may become co-mingled on the surface of the substrate 18. The layer(s) 23, 25 disposed on the non-porous, non-paper-based substrate 18 may be heated in the printing zone 24 (for example, the air temperature in the printing zone 24 may range from about 10° C. to about 90° C.) such that water may be evaporated from the pre-treatment layer 23 and ink layer 25. Heating in the printing zone 24 is presented by arrows D. In some examples, heating in the printing zone 24 may be performed by a heater or fan 32 blowing air over the non-porous, non-paper-based substrate 18 passing through the printing zone 24.

The non-porous, non-paper-based substrate 18 (having the pre-treatment layer 23 and ink layer 25 printed thereon) may then be transported to the curing zone 28 where the layers are heated to a temperature above the MFFT of the ink layer 25 to initiate curing and form the polymeric film 27. In one example, the air temperature in the curing zone 28 may range from about 60° C. to about 140° C. In the curing zone 28, warm/hot air is blown onto the non-porous, non-paper-based substrate 18 (as shown by arrows E) such that the water and/or the solvent(s) are at least partially evaporated from the pre-treatment layer 23 and the ink layer 25 and the latex particles 13, 13′, 13″ are heated to a temperature above the MFFT of the ink layer 25.

In some instances, the fluids 12, 14 are printed bi-directionally, and thus the pre-treatment fluid 12 may be printed under and over the inkjet ink 14.

In some examples of the method, the overcoat fluid 16 is applied after the inkjet ink 14.

To further illustrate the present disclosure, examples are given herein. It is to be understood that these examples are provided for illustrative purposes and are not to be construed as limiting the scope of the present disclosure.

### EXAMPLES

In the following examples, pre-treatment fluid is described as being printed before ink, and ink is described as being printed before overcoat fluid (if used). The inkjet pens used to dispense the fluids were slightly staggered, where the pre-treatment fluid pens led the ink pens, and the overcoat fluid pens trailed behind the ink pens. With this pen configuration, one fluid was printed slightly in advance of the next fluid, and the exact order of the fluids contacting the medium may have varied. This pen configuration enabled wet on wet printing.

### Example 1

Three example pre-treatment fluids and a comparative example pre-treatment were prepared. The formulations for these fluids are shown in Table 9. The values shown represent wt % active amounts. The example pre-treatments fluids (Ex. PT 1-Ex. PT 3) included a copolymer including an epihalohydrin and an amine (namely POLYCUP® 7360A, which has non-quaternary amine groups) or a combination of POLYCUP® 7360A and FLOQUAT® FL 2350, and the comparative pre-treatment fluid (Comp. PT 4) included FLOQUAT® FL 2350 (a quaternary amine with chloride counterions derived from polymerization of epichlorohydrin and dimethyl amine).

TABLE 9

| Component | | Ex. PT | Ex. PT | Ex. PT | Comp. |
|---|---|---|---|---|---|
| Type | Component | 1 | 2 | 3 | PT 4 |
| Co-solvent | 1,2- | 20.1 | 20.1 | 20.1 | 20.1 |
| | butanediol | | | | |
| Surfactant | secondary | 0.2 | 0.2 | 0.2 | 0.2 |
| | alcohol | | | | |
| | ethoxylate | | | | |
| | siloxane- | 0.5 | 0.5 | 0.5 | 0.5 |
| | based | | | | |
| | gemini | | | | |
| | surfactant | | | | |
| Cationic | POLYCUP ® | 2.5 | 5 | 2.5 | — |
| polymer | 7360A | | | | |
| | FLOQUAT ® | — | — | 2.5 | 2.5 |
| | FL 2350 | | | | |
| Acid | Succinic | 0.9 | 0.9 | 0.9 | 0.9 |
| | acid | | | | |
| Water | Deionized | Balance | Balance | Balance | Balance |
| | water | | | | |

Each of the example and comparative pre-treatment fluids was inkjet printed (using a thermal inkjet printer) on three different rigid media, including PLEXIGLAS® (acrylic sheet), DIBOND® (aluminium composite panel), and INTEPRO® (fluted polypropylene). After the respective pre-treatment fluids was applied on the respective media, an ink containing the latex polymer particles disclosed herein was inkjet printed on the pre-treatment layers. The printed media were then exposed to heat at a temperature ranging from about 60° C. to about 90° C. The ink composition is generally shown in Table 10.

TABLE 10

| Ink Component | Wt % Active |
|---|---|
| black pigment | 2.6 |
| multi-phase latex particles | 10.0 |
| co-solvent | 20.5 |
| surfactants | 0.5 |
| anti-kogation agent | 0.2 |
| water | Balance |

Each example and comparative example print was exposed to a chemical resistance test. For this test, a TABER® abrasion tool was used. The cloth of the abrasion tool was dipped in WINDEX® glass cleaner and was rubbed across 3 mm patches of each print 10 times. All of the tested patches were visually inspected for ink defects, such as ink removal, smear, etc., and graded according to the scale described in Table 11.

TABLE 11

| Score | Description |
|---|---|
| 0-1 | No defects observed |
| 2 | Very minor defects at 1M distance |
| 3 | Unacceptable level of defects, some ink removal |
| 4 | High level of defects, significant ink removal |
| 5 | Severe defects and extensive ink removal |

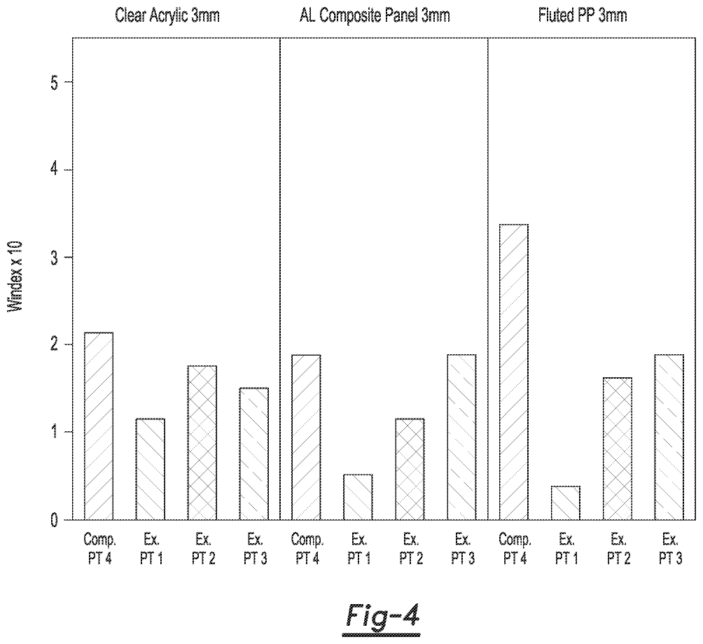

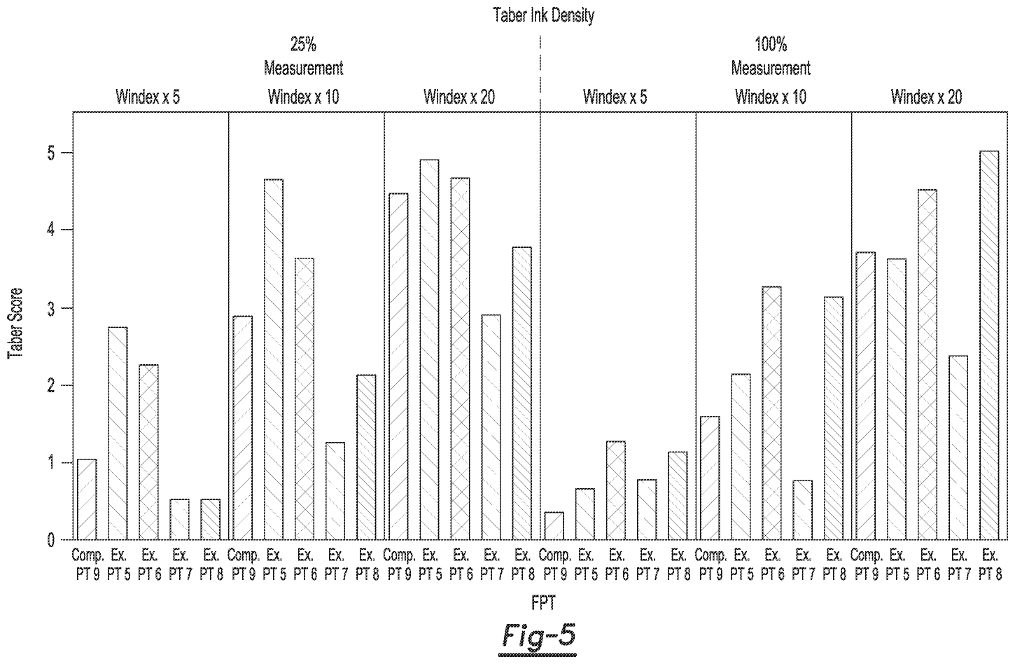

The results are shown in FIG. 4. In FIG. 4, the prints are identified on the X axis by the pre-treatment fluid used to generate the print. As illustrated, the prints generated with the example pre-treatment fluids (each of which included the copolymer including the epihalohydrin and the amine with non-quaternary amine groups) exhibited improved chemical resistance on each type of rigid media when compared to the prints generated with the comparative pre-treatment fluid (which included a quaternary amine with chloride counterions derived from polymerization of epichlorohydrin and dimethyl amine).

### Example 2

Four example pre-treatment fluids and a comparative example pre-treatment were prepared. The formulations for these fluids are shown in Table 12. The values shown represent wt % active amounts. The example pre-treatments fluids (Ex. PT 5-8) included a polycarbodiimide (namely PICASSIAN® XL 702 or PICASSIAN® XL 732) or a combination of PICASSIAN® XL and FLOQUAT® FL 2350, and the comparative pre-treatment fluid (Comp. PT 9) included FLOQUAT® FL 2350.

TABLE 12

| Component | | Ex. PT | Ex. PT | Ex. PT | Ex. PT | Comp. PT |
|---|---|---|---|---|---|---|
| Type | Component | 5 | 6 | 7 | 8 | 9 |
| Co-solvent | 1,2- | 20.1 | 20.1 | 20.1 | 20.1 | 20.1 |
| | butanediol | | | | | |
| Surfactant | secondary | 0.2 | 0.2 | 0.2 | 0.2 | 0.2 |
| | alcohol | | | | | |
| | ethoxylate | | | | | |
| | siloxane- | 0.5 | 0.5 | 0.5 | 0.5 | 0.5 |
| | based gemini | | | | | |
| | surfactant | | | | | |
| Cationic | PICASSIAN ® | 2.5 | — | 2.5 | — | — |
| polymer | XL 702 | | | | | |
| | PICASSIAN ® | — | 2.5 | — | 2.5 | — |
| | XL 732 | | | | | |
| | FLOQUAT ® | 2.5 | 2.5 | — | — | 2.5 |
| | FL 2350 | | | | | |
| Acid | Succinic acid | 0.9 | 0.9 | 0.9 | 0.9 | 0.9 |
| Water | Deionized | Balance | Balance | Balance | Balance | Balance |
| | water | | | | | |

Each of the example and comparative pre-treatment fluids was inkjet printed (using a thermal inkjet printer) on a flexible medium, namely LINTEC® 1000 (polyethylene terephthalate). After the respective pre-treatment fluids were applied on the respective media, the ink of Example 1 was inkjet printed on the pre-treatment layers. After the ink was printed, an overcoat fluid was inkjet printed on the ink. The printed media were then exposed to heat at a temperature ranging from about 60° C. to about 90° C. The overcoat fluid composition is generally shown in Table 13.

TABLE 13

| Ink Component | Wt % Active |
|---|---|
| wax | 6.0 |
| multi-phase latex particles | 9.6 |
| co-solvent | 30.0 |
| surfactants | 0.7 |
| anti-kogation agent | 0.2 |
| anti-microbial | 0.002 |
| water | Balance |

Some prints were generated with 25% ink density (about 0.625 dpp) and other prints were generated with 100% ink density (about 2.5 dpp).

Each example and comparative example print was exposed to a chemical resistance test. For this test, a TABER® abrasion tool was used. The cloth of the abrasion tool was dipped in WINDEX® glass cleaner and was rubbed across respective 3 mm patches of each print for 5 times, 10 times, or 20 times. All of the tested patches were assigned a Taber Wear Index score, which indicates the rate of wear and is calculated by measuring the loss in weight (in milligrams) per thousand cycles of abrasion. A lower score indicates less wear.

The results are shown in FIG. 5. In FIG. 5, the prints are identified on by the pre-treatment fluid used to generate the print. As illustrated, the prints generated with example pre-treatment fluid 7 (which included the polycarbodiimide without the quaternary amine with chloride counterions derived from polymerization of epichlorohydrin and dimethyl amine) exhibited improved chemical resistance on the PET rigid media when compared to the prints generated with the comparative pre-treatment fluid (which included a quaternary amine with chloride counterions derived from polymerization of epichlorohydrin and dimethyl amine). With increasing rubs, the prints generated with example pre-treatment fluid 7 abraded slower than the comparative example prints. At 25% ink density, the prints generated with example pre-treatment fluid 8 (which included the polycarbodiimide without the quaternary amine with chloride counterions derived from polymerization of epichlorohydrin and dimethyl amine) also exhibited improved chemical resistance on the PET rigid media.

### Example 3

Four example pre-treatment fluids were prepared. The formulations for these fluids are shown in Table 14. The values shown represent wt % active amounts. The example pre-treatments fluids (Ex. PT 10-13) included a combination of an acrylic emulsion polymer having quaternary and tertiary amine groups (namely RAYCAT® 78) and FLOQUAT® FL 2350. In these example pre-treatment fluids, a coalescing solvent (e.g., propylene glycol alkyl ether) was added in some of the formulations.

TABLE 14

| Component | | Ex. PT | Ex. PT | Ex. PT | Ex. PT |
|---|---|---|---|---|---|
| Type | Component | 10 | 11 | 12 | 13 |
| Co-solvent | propylene | — | 2 | 4 | 6 |
| | glycol alkyl | | | | |
| | ether | | | | |
| | 1,2- | 20.1 | 20.1 | 20.1 | 20.1 |
| | butanediol | | | | |
| Surfactant | secondary | 0.2 | 0.2 | 0.2 | 0.2 |
| | alcohol | | | | |
| | ethoxylate | | | | |
| | siloxane- | 0.5 | 0.5 | 0.5 | 0.5 |
| | based gemini | | | | |
| | surfactant | | | | |
| Cationic | RAYCAT ® | 10 | 10 | 10 | 10 |
| polymer | 78 | | | | |
| | FLOQUAT ® | 2.5 | 2.5 | 2.5 | 2.5 |
| | FL 2350 | | | | |
| Acid | Succinic acid | 0.9 | 0.9 | 0.9 | 0.9 |
| Water | Deionized | Balance | Balance | Balance | Balance |
| | water | | | | |

Each of the example pre-treatment fluids was inkjet printed (using a thermal inkjet printer) on a flexible medium, namely LINTEC® 1000 (polyethylene terephthalate). After the respective pre-treatment fluids were applied on the medium, the ink of Example 1 was inkjet printed on the pre-treatment layers. After the ink was printed, the overcoat fluid of Example 1 was inkjet printed on the ink. The printed media were then exposed to heat at a temperature ranging from about 60° C. to about 90° C.

Each example print was exposed to a chemical resistance test. For this test, a TABER® abrasion tool was used. The cloth of the abrasion tool was dipped in WINDEX® glass cleaner and was rubbed across respective 3 mm patches of each print for 5 times, 10 times, or 20 times. All of the tested patches were assigned a Taber Wear Index score, which indicates the rate of wear and is calculated by measuring the loss in weight (in milligrams) per thousand cycles of abrasion.

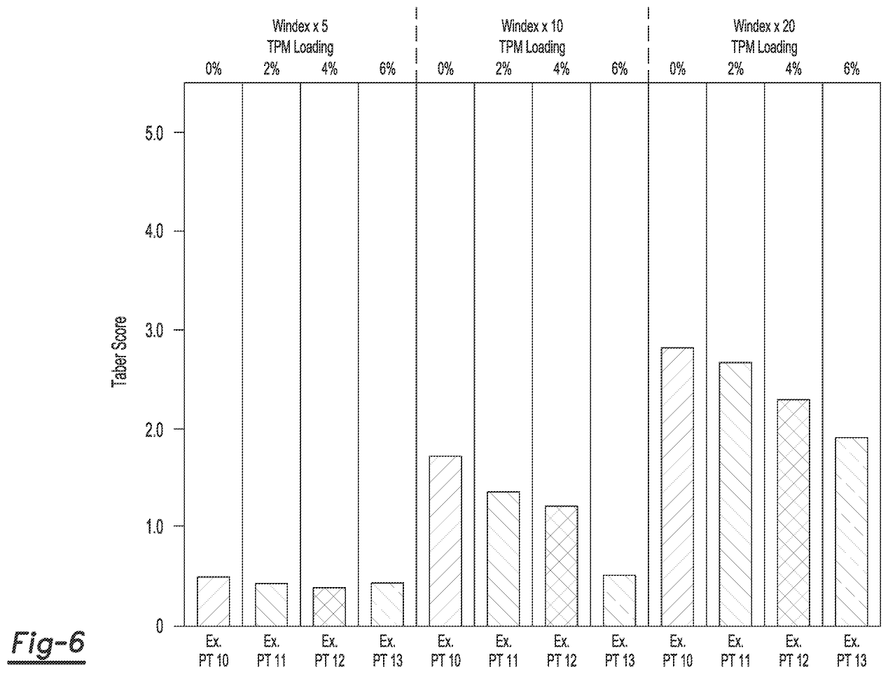

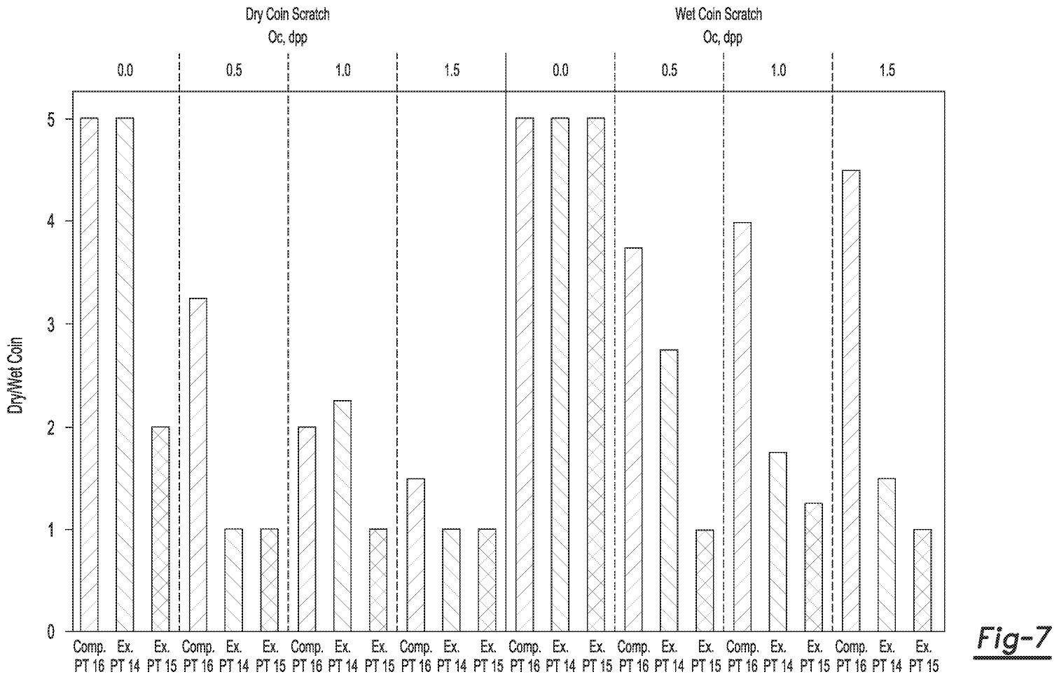

The results are shown in FIG. 6, and the prints are identified by the pre-treatment fluid used to generate the print. As illustrated, the addition of the coalescing solvent, i.e., the propylene glycol alkyl ether, improved the chemical resistance of the prints on the PET rigid medium.

### Example 4

Two example pre-treatment fluids were prepared. The formulations for these fluids are shown in Table 15. The values shown represent wt % active amounts. The example pre-treatments fluids (Ex. PT 14-15) included a combination of an acrylic emulsion polymer having quaternary and tertiary amine groups (namely RAYCAT® 78) and FLOQUAT® FL 2350. A comparative pre-treatment fluid (Comp. PT 16) included FLOQUAT® FL 2350.

TABLE 15

| Component | | Ex. PT | Ex. PT | Comp. PT |
|---|---|---|---|---|
| Type | Component | 14 | 15 | 16 |
| Co-solvent | 1,2-butanediol | 20.1 | 20.1 | 20.1 |
| Surfactant | secondary alcohol | 0.2 | 0.2 | 0.2 |
| | ethoxylate | | | |
| | siloxane-based | 0.5 | 0.5 | 0.5 |
| | gemini surfactant | | | |
| Cationic | RAYCAT ® 78 | 5 | 10 | — |
| polymer | FLOQUAT ® FL | 2.5 | 2.5 | 2.5 |
| | 2350 | | | |
| Acid | Succinic acid | 0.9 | 0.9 | 0.9 |
| Water | Deionized water | Balance | Balance | Balance |

Each of the example pre-treatment fluids 14, 15 and the comparative pre-treatment fluid 16 was inkjet printed (using a thermal inkjet printer) on two different rigid media, namely DIBOND® (aluminium composite panel) and PLEXIGLAS® (acrylic sheet). Example pre-treatment fluid 15 and comparative pre-treatment fluid 16 were also inkjet printed (using a thermal inkjet printer) on the rigid medium, INTEPRO® Fluted Polypropylene. After the respective pre-treatment fluids were applied on the respective media, the ink of Example 1 was inkjet printed on the pre-treatment layers. After the ink was printed, the overcoat fluid of Example 2 was inkjet printed on the ink. The loading of the overcoat fluid was varied (0 dpp, 0.5 dpp, 1.0 dpp, 1.5 dpp) to compare the effect of the pre-treatment layers without the overcoat fluid and with different amounts of the overcoat fluid. The printed media were then exposed to heat at a temperature ranging from about 60° C. to about 90° C.

The prints were tested for scratch resistance and/or dry rub to determine the abrasion resistance and adhesion.

The example and comparative prints generated on DIBOND® were exposed to dry and wet coin scratch resistance test. The coin was an unstruck metal disk. Prior to the test, the coin was examined and if wear was depicted, it was rotated to a fresh area. A weight (250 g) was placed on the coin holder. The coin was held at an oblique angle and was dragged 3 times (forwards and backwards) as the weight was applied. For the dry coin scratch test, the coin was dragged across the dry print in the manner described herein. For the wet coin scratch test, a cloth wet with water was rubbed across the print and then the coin was dragged across the wet print in the manner described herein. All of the tested patches were visually inspected for ink defects, such as ink removal, smear, etc., and graded according to the scale described in Table 11.

The results for dry and wet coin scratch are shown in FIG. 7. The overcoat fluid amount (in dpp) is identified at the top of the figure, and each of the prints is identified by the pre-treatment fluid used to generate the print. The example prints exhibited improved dry and wet coin scratch performance when compared to the comparative prints. The improvement in scratch resistance for the example prints over all overcoat levels indicates an improvement in adhesion of the ink to the underlying substrate. While the presence of the overcoat fluid at higher levels improves the wet coin scratch resistance and thus the durability, the dry coin scratch results for example print 15 generated without the overcoat fluid indicate that example pre-treatment fluid 15 had an impact on the dry coin scratch resistance and durability even without the overcoat fluid.

The example and comparative prints generated on INTEPRO® were exposed to a dry rub test. For this test, the TABER® abrasion tool was used. The cloth of the abrasion tool was dry and was rubbed across 3 mm patches of each print 10 times. All of the tested patches were visually inspected for ink defects, such as ink removal, smear, etc., and graded according to the scale described in Table 11.

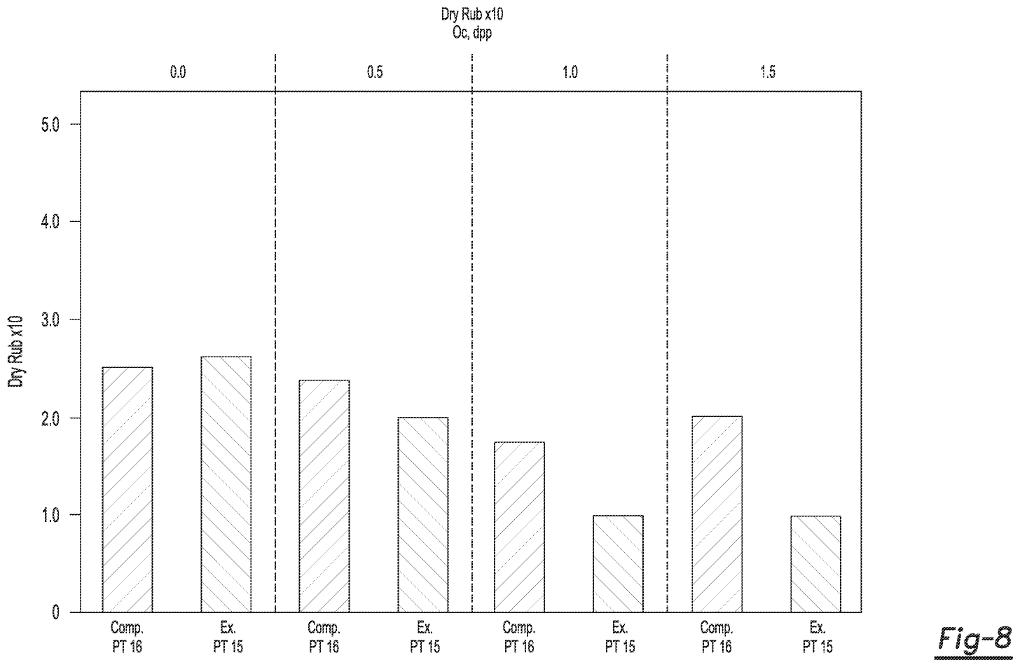

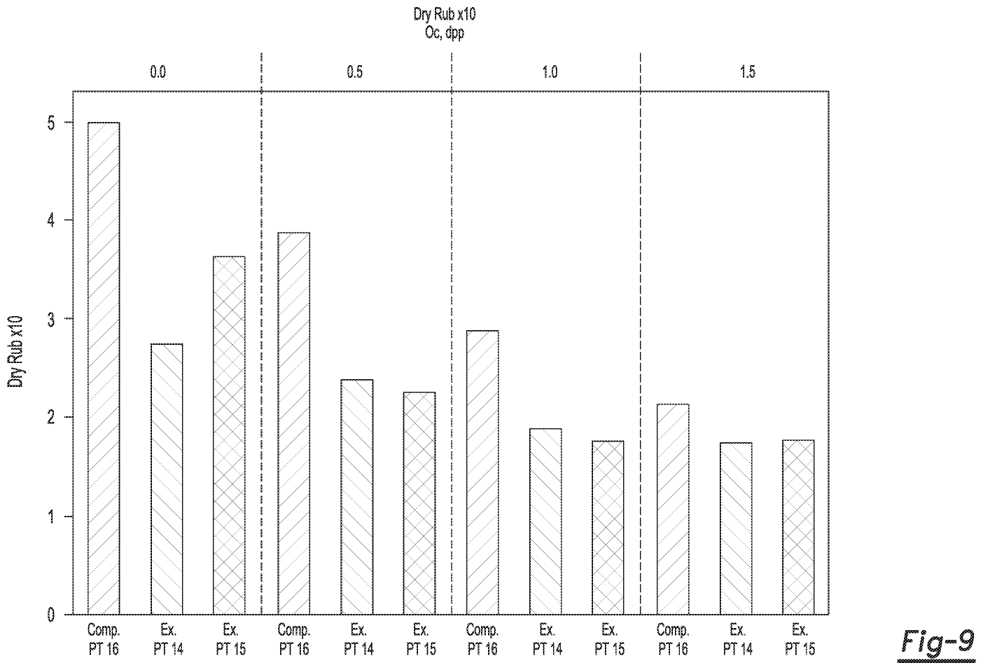

The results are shown in FIG. 8. Without the overcoat fluid, the print generated with the example pre-treatment fluid 15 performed comparably to the comparative pre-treatment fluid 16. The combination of example pre-treatment fluid 15 and the overcoat fluid improved the dry rub performance on the fluted polypropylene medium.

The example and comparative prints generated on PLEXIGLAS® were also exposed to the dry rub test as described in this example. The results are shown in FIG. 9. In FIG. 9, the prints are identified by the pre-treatment fluid used to generate the print. As illustrated, both without the overcoat fluid and with the overcoat fluid, prints generated with the example pre-treatments 14, 15 exhibited improved dry rub performance on the acrylic sheet medium. The result also indicate that increased levels of the overcoat fluid can further improve the dry rub performance

The overall improvement in abrasion resistance for prints generated using the example pre-treatment fluids 14, 15 equate to improved adhesion between the ink and the underlying non-porous media.

It is to be understood that the ranges provided herein include the stated range and any value or sub-range within the stated range, as if the value(s) or sub-range(s) within the stated range were explicitly recited. For example, a range from about 5 wt % active to about 20 wt % active, should be interpreted to include not only the explicitly recited limits of from about 5 wt % active to about 20 wt % active, but also to include individual values, such as about 5.75 wt % active, 8 wt % active, 11 wt % active, 14.5 wt % active, etc., and sub-ranges, such as from about 5 wt % active to about 15 wt % active, from about 6 wt % active to about 10 wt % active, from about 12.75 wt % active to about 19.75 wt % active, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet fluid set, comprising:
a pre-treatment fluid including:
a first aqueous vehicle; and
a water resistance and adhesion promoting cationic polymer dissolved or dispersed in the first aqueous vehicle; and
an inkjet ink including:
a second aqueous vehicle;
a pigment dispersed throughout the second aqueous vehicle; and
multi-phase latex particles dispersed throughout the second aqueous vehicle, each multi-phase latex particle including at least two different heteropolymers defining at least two different phases of the multi-phase latex particle.

2. The inkjet fluid set as defined in claim 1, wherein a weight average molecular weight of the water resistance and adhesion promoting cationic polymer ranges from about 1,000 g/mol to about 500,000 g/mol.

3. The inkjet fluid set as defined in claim 1, wherein the water resistance and adhesion promoting cationic polymer is present in the pre-treatment fluid in an amount ranging from about 1 wt % active to about 10 wt % active based on a total weight of the pre-treatment fluid.

4. The inkjet fluid set as defined in claim 1, wherein the adhesion promoting cationic polymer is selected from the group consisting of a copolymer including an epihalohydrin and an amine; an acrylic emulsion polymer having quaternary and tertiary amine groups; a polycarbodiimide; and combinations thereof.

5. The inkjet fluid set as defined in claim 1, wherein the first aqueous vehicle includes water, a co-solvent, and a surfactant.

6. The inkjet fluid set as defined in claim 1, further comprising an overcoat fluid.

7. The inkjet fluid set as defined in claim 1, further comprising a second cationic polymer dissolved in the first aqueous vehicle.

8. The inkjet fluid set as defined in claim 1, wherein the at least two different heteropolymers of the multi-phase latex particles are selected such that:
a cumulative percentage of any heteropolymers of the at least two different heteropolymers including less than 30% of a C6 or greater (meth)acrylate monomer ranges from about 20 wt % to about 80 wt % of a total weight of the multi-phase latex particle;
a cumulative percentage of any heteropolymers of the at least two different heteropolymers having a glass transition temperature (T_{g}) ranging from 15° C. to 75° C. ranges from about 30 wt % to about 70 wt % of the total weight of the multi-phase latex particle;
a cumulative percentage of any heteropolymers of the at least two different heteropolymers having a glass transition temperature (T_{g}) greater than 75° C. is greater than 30 wt % of the total weight of the multi-phase latex particle; and
a cumulative percentage of an aromatic group monomer in the multi-phase latex particle composition is less than 10 wt % of the total weight of the multi-phase latex particle.

9. The inkjet fluid set as defined in claim 8, wherein:
a first heteropolymer of the at least two different heteropolymers in the inkjet ink includes less than 30% of the C6 or greater (meth)acrylate monomer and has the Tg ranging from 15° C. to 75° C.; and
a second heteropolymer of the at least two different heteropolymers in the inkjet ink includes greater than 30% of the C6 or greater (meth)acrylate monomer and has the Tg greater than 75° C.

10. The inkjet fluid set as defined in claim 8, wherein:
a first heteropolymer of the at least two different heteropolymers in the inkjet ink includes greater than 30% of the C6 or greater (meth)acrylate monomer and has the Tg ranging from 15° C. to 75° C.; and
a second heteropolymer of the at least two different heteropolymers in the inkjet ink includes less than 30% of the C6 or greater (meth)acrylate monomer and has the Tg greater than 75° C.

11. An inkjet printing kit, comprising:
a non-porous, non-paper-based substrate;
a pre-treatment fluid including:
a first aqueous vehicle; and
a water resistance and adhesion promoting cationic polymer dissolved or dispersed in the first aqueous vehicle; and
an inkjet ink including:
a second aqueous vehicle;
a pigment dispersed throughout the second aqueous vehicle; and
multi-phase latex particles dispersed throughout the second aqueous vehicle, each of the multi-phase latex particles including at least two different heteropolymers defining at least two different phases of the multi-phase latex particle.

12. The inkjet printing kit as defined in claim 11, wherein the non-porous, non-paper-based substrate has a surface energy lower than 50 dynes/cm.

13. A method, comprising:
inkjet printing a pre-treatment fluid on at least a portion of a non-porous, non-paper-based substrate, the pre-treatment fluid including:
a first aqueous vehicle; and
a water resistance and adhesion promoting cationic polymer dissolved or dispersed in the first aqueous vehicle; and
inkjet printing an inkjet ink on at least a portion of the pre-treatment fluid, the inkjet ink including:
a second aqueous vehicle;
a pigment dispersed throughout the second aqueous vehicle; and
multi-phase latex particles dispersed throughout the second aqueous vehicle, each of the multi-phase latex particles including at least two different heteropolymers defining at least two different phases of the multi-phase latex particle.

14. The method as defined in claim 13, wherein the inkjet ink is printed on the at least the portion of the pre-treatment fluid while the pre-treatment fluid is wet.

15. The method as defined in claim 13, further comprising curing the inkjet ink.
